(19) United States
(12) Patent Application Publication
(10) Pub. No.: US 2025/0197219 A1
(43) Pub. Date: Jun. 19, 2025

(54) SILICON-CONTAINING ALUMINUM NITRIDE PARTICLES, SINTERED BODY, RESIN COMPOSITION, AND METHOD FOR PRODUCING SILICON-CONTAINING ALUMINUM NITRIDE PARTICLES

(71) Applicant: NICHIA CORPORATION, Anan-shi (JP)

(72) Inventors: Shimpei KINOSHITA, Anan-shi (JP); Hiroyuki WATANABE, Itano-gun (JP); Masafumi SAKAMOTO, Anan-shi (JP)

(73) Assignee: NICHIA CORPORATION, Anan-shi (JP)

(21) Appl. No.: 18/979,500

(22) Filed: Dec. 12, 2024

(30) Foreign Application Priority Data
Dec. 13, 2023 (JP) 2023-209889
Jul. 30, 2024 (JP) 2024-123513

(51) Int. Cl. C01B 21/06; C08K 3/34

(52) U.S. Cl. CPC C01B 21/0602; C08K 3/34; C01P 2002/54; C01P 2002/72; C01P 2002/74; C01P 2002/84; C01P 2002/88; C01P 2004/03; C01P 2004/61; C01P 2004/62; C01P 2004/64; C01P 2006/12; C01P 2006/60; C08K 2201/005; C08K 2201/011

(57) ABSTRACT

Silicon-containing aluminum nitride particles contain a ratio of a total of a mass of aluminum and a mass of nitrogen of 90% by mass or more, and a ratio of a mass of silicon of 1.5% by mass or more and 10.0% by mass or less relative to a total of the mass of aluminum and the mass of silicon, as obtained by analyzing particles using an inductively coupled plasma-atomic emission spectroscope, and a mass of oxygen and the mass of nitrogen, as obtained by analyzing the particles using an oxygen/nitrogen analyzer, being 100% by mass, wherein a ratio (X/Y) is 0.40 or more and 0.85 or less, a ratio of the mass of oxygen is denoted as X % by mass, a specific surface area of the particles, as measured according to a BET method, is denoted as Y m²/g.

### CROSS-REFERENCE TO RELATED PATENT APPLICATION

This application claims priority to Japanese Patent Application No. 2024-123513, filed on Jul. 30, 2024, and Japanese Patent Application No. 2023-209889, filed on Dec. 13, 2023, the entire disclosures of which are hereby incorporated by references in their entirety.

### BACKGROUND

### Technical Field

The present disclosure relates to silicon-containing aluminum nitride particles, a sintered body, a resin composition, and a method for producing silicon-containing aluminum nitride particles.

### Description of Related Art

Light emitting devices that emit white light, bulb color light, or orange light have been developed by combining a light emitting element and a fluorescent material. To form light emitting devices, various materials are used, such as die-bonding materials for fixing a light emitting element to a support or lead electrode, underfill materials to be placed between a light emitting element and a support substrate or lead electrode in flip-chip mounting, and packaging materials for fixing and holding a light emitting element and acting as reflectors. Resin materials containing fillers are used as materials constituting the members of light emitting devices, such as die bonding materials, underfill materials, and packaging materials. Aluminum nitride particles are known to have higher thermal conductivity than oxides such as aluminum oxide. Sintered bodies obtained by sintering aluminum nitride particles have excellent heat dissipation properties and may be used as supports for electronic components. Fillers and sintered bodies are required to have high thermal conductivity for heat dissipation and high reflectance for light in a specific wavelength range.

Japanese Unexamined Patent Publication No. 2012-064928 discloses a resin material for a molded body serving as a support for a semiconductor light emitting element, which contains polyorganosiloxane, boron nitride or aluminum nitride having a primary particle diameter of 0.1 μm or more and 7.0 μm or less, and a curing catalyst.

### SUMMARY

In the case of using aluminum nitride particles as a filler, when the aluminum nitride particles are brought into contact with a resin, the aluminum nitride reacts with moisture contained in the resin to generate ammonia (NH₃), which may inhibit curing of the resin. In addition, aluminum nitride particles contained in a cured product or sintered body react with moisture to generate ammonia (NH₃), which may cause the cured product or sintered body to deteriorate.

An object of the present disclosure is to provide silicon-containing aluminum nitride particles, a sintered body, a resin composition, and a method for producing silicon-containing aluminum nitride particles, which are highly moisture resistant and less likely to react with moisture while maintaining high thermal conductivity of aluminum nitride.

According to a first aspect of the present disclosure, silicon-containing aluminum nitride particles contain a ratio of a total of a mass of aluminum and a mass of nitrogen of 90% by mass or more, and a ratio of a mass of silicon of 1.5% by mass or more and 10.0% by mass or less relative to a total of the mass of aluminum and the mass of silicon, as obtained by analyzing particles using an inductively coupled plasma-atomic emission spectroscope, and the mass of nitrogen and a mass of oxygen, as obtained by analyzing the particles using an oxygen/nitrogen analyzer, being 100% by mass, wherein a ratio (X/Y) of a numerical value X of the X % by mass to a numerical value Y of the Y m²/g is 0.40 or more and 0.85 or less, a ratio of the mass of oxygen is denoted as X % by mass, a specific surface area of the particles, as measured according to a BET method, is denoted as Y m²/g.

According to a second aspect of the present disclosure, silicon-containing aluminum nitride particles contain a ratio of a total of a mass of aluminum and a mass of nitrogen of 90% by mass or more, and a ratio of a mass of silicon of 1.5% by mass or more and 10.0% by mass or less relative to a total of the mass of aluminum and the mass of silicon, as obtained by analyzing particles using an inductively coupled plasma-atomic emission spectroscope, and the mass of nitrogen and a mass of oxygen, as obtained by analyzing the particles using an oxygen/nitrogen analyzer, being 100% by mass, wherein a ratio O^{P}/N^{P} of an oxygen atomic percentage O^{P} to a nitrogen atomic percentage N^{P}, as obtained by analyzing the particles according to X-ray photoelectron spectroscopy, is more than 2.0.

According to a third aspect of the present disclosure, a sintered body containing the silicon-containing aluminum nitride particles.

According to a fourth aspect of the present disclosure, a resin composition containing the silicon-containing aluminum nitride particles and a resin.

According to a fifth aspect of the present disclosure, a method for producing silicon-containing aluminum nitride particles including: mixing aluminum nitride and silicon nitride to obtain a raw material mixture containing silicon nitride in an amount of 2% by mass or more and 15% by mass or less relative to a total of aluminum nitride and silicon nitride being 100% by mass; subjecting the raw material mixture to a first heat treatment at a pressure of 0.101 MPa or more and a temperature of 1,600° C. or higher and 2,100° C. or lower to obtain a first heat-treated product; and subjecting the obtained first heat-treated product to a second heat treatment at a temperature of 850° C. or higher and lower than 1,000° C. to obtain a second heat-treated product.

According to certain aspects of the present disclosure, silicon-containing aluminum nitride particles, a sintered body, a resin composition, and a method for producing silicon-containing aluminum nitride particles, which are highly moisture resistant and less likely to react with moisture while maintaining high thermal conductivity and high reflectance can be provided.

### BRIEF DESCRIPTION OF THE DRAWINGS

FIG. 1 is a schematic cross-sectional view showing an example of a light emitting device according to the present disclosure.

FIG. 2 shows X-ray diffraction patterns of silicon-containing aluminum nitride particles according to Examples 1 to 5 and Comparative Examples 3 to 5, and X-ray diffraction patterns of aluminum nitride particles according to Comparative Examples 1 and 2.

FIG. 3 shows reflectance spectra of silicon-containing aluminum nitride particles according to Examples 1 to 3 and a reflectance spectrum of aluminum nitride particles according to Comparative Example 1.

FIG. 4 shows reflectance spectra of silicon-containing aluminum nitride particles according to Examples 4 and 5 and a reflectance spectrum of aluminum nitride particles according to Comparative Example 1.

FIG. 5 is an SEM micrograph of silicon-containing aluminum nitride particles according to Example 1.

FIG. 6 is an SEM micrograph of silicon-containing aluminum nitride particles according to Example 4.

FIG. 7 is an SEM micrograph of aluminum nitride particles according to Comparative Example 1.

FIG. 8 shows DSC curves of samples 1 to 3.

FIG. 9 shows X-ray diffraction patterns of silicon-containing aluminum nitride particles according to Examples 6 and 7 and Comparative Example 6, and an X-ray diffraction pattern of aluminum nitride particles according to Comparative Example 7.

FIG. 10 shows reflectance spectra of silicon-containing aluminum nitride particles according to Examples 6 and 7 and Comparative Example 6, and a reflectance spectrum of aluminum nitride particles according to Comparative Example 7.

FIG. 11 is an SEM micrograph of silicon-containing aluminum nitride particles according to Example 6.

FIG. 12 is an SEM micrograph of aluminum nitride particles according to Comparative Example 7.

### DETAILED DESCRIPTION

The following describes silicon-containing aluminum nitride particles, a sintered body, a resin composition, and a method for producing silicon-containing aluminum nitride particles according to the present disclosure. Embodiments described below are exemplifications for giving a concrete form to the technical idea of the present disclosure, and the present invention is not limited to the following silicon-containing aluminum nitride particles, the sintered body, the resin composition, and the method for producing silicon-containing aluminum nitride particles. The relationships between color names and chromaticity coordinates, and the relationships between wavelength ranges of light and color names of monochromatic lights in the present specification are in accordance with Japanese Industrial Standard (JIS) Z8110. In this specification, the “fluorescent material” is used in the same meaning as a “fluorescent phosphor”.

The silicon-containing aluminum nitride particles contain a ratio of a total of a mass of aluminum and a mass of nitrogen of 90% by mass or more, and a ratio of a mass of silicon of 1.5% by mass or more and 10.0% by mass or less relative to a total of the mass of aluminum and the mass of silicon, as obtained by analyzing particles using an inductively coupled plasma-atomic emission spectroscope (hereinafter also referred to as “ICP”), and the mass of nitrogen and a mass of oxygen, as obtained by analyzing the particles using an oxygen/nitrogen analyzer, being 100% by mass, wherein a ratio (X/Y) of a numerical value X of the X % by mass to a numerical value Y of the Y m²/g is 0.40 or more and 0.85 or less, a ratio of the mass of oxygen is denoted as X % by mass, a specific surface area of the particles, as measured according to a BET method, is denoted as Y m²/g, and.

The silicon-containing aluminum nitride particles contain a ratio of a total of a mass of aluminum and a mass of nitrogen of 90% by mass or more, and a ratio of a mass of silicon of 1.5% by mass or more and 10.0% by mass or less relative to a total of the mass of aluminum and the mass of silicon, as obtained by analyzing particles using ICP, and the mass of nitrogen and a mass of oxygen, as obtained by analyzing the particles using an oxygen/nitrogen analyzer, being 100% by mass, wherein a ratio O^{P}/N_{P} of an oxygen atomic percentage O^{P} to a nitrogen atomic percentage N^{P}, as obtained by analyzing the particles according to X-ray photoelectron spectroscopy, is more than 2.0.

The silicon-containing aluminum nitride particles are analyzed for the mass of aluminum and the mass of silicon in the silicon-containing aluminum nitride particles by ICP. In addition, the silicon-containing aluminum nitride particles are analyzed for the mass of nitrogen and the mass of oxygen in the silicon-containing aluminum nitride particles by the oxygen/nitrogen analyzer. The silicon-containing aluminum nitride particles have a ratio of a total of the mass of aluminum and the mass of nitrogen of 90% by mass or more, and a ratio of the mass of silicon of 1.5% by mass or more and 10.0% by mass or less, relative to a total of the mass of aluminum, the mass of silicon, the mass of nitrogen, and the mass of oxygen, as analyzed by the apparatuses described above, being 100% by mass. When the silicon-containing aluminum nitride particles have a ratio of the total of the mass of aluminum and the mass of nitrogen (% by mass) and a ratio of the mass of silicon (% by mass) within the above range relative to the total of the mass of aluminum, the mass of silicon, the mass of nitrogen, and the mass of oxygen, as obtained by analyzing the particles by the apparatuses described above, being 100% by mass, a part of aluminum in the crystal structure of the aluminum nitride is substituted with silicon while maintaining the crystal structure of the aluminum nitride. When a part of aluminum in the crystal structure of the aluminum nitride is substituted with silicon, the silicon-containing aluminum nitride particles have a high reflectance. In the present specification, the high reflectance that the silicon-containing aluminum nitride particles have means that the reflectance for light within a wavelength range of, for example, 380 nm or more and 730 nm or less (hereinafter also referred to as “within the wavelength range of the visible light region”) is 50% or more. Aluminum nitride particles have high thermal conductivity, generally 150 W/m·K to 200 W/m·K at 20° C. Meanwhile, the aluminum nitride particles generally have a reflectance of about 70% within the wavelength range of the visible light region. By substituting a part of aluminum in the crystal structure with silicon while maintaining the crystal structure of the aluminum nitride, the silicon-containing aluminum nitride particles can increase the reflectance for light within the wavelength range of the visible light region while maintaining the high thermal conductivity that the aluminum nitride particles have. In addition, when the silicon-containing aluminum nitride particles have a ratio of the mass of silicon within the above range relative to the total of the mass of aluminum, the mass of silicon, the mass of nitrogen, and the mass of oxygen, as obtained by analyzing the particles by the apparatuses described above, being 100% by mass, the reaction between aluminum and oxygen in the silicon-containing aluminum nitride particles can be inhibited to form an oxygen-containing film while inhibiting the formation of aluminum oxide (Al₂O₃). The silicon-containing aluminum nitride particles may have a ratio of the total of the mass of aluminum and the mass of nitrogen of 92% by mass or more, or 93% by mass or more, and preferably have a ratio of 98% by mass or less, relative to the total of the mass of aluminum, the mass of silicon, the mass of nitrogen, and the mass of oxygen, as obtained by analyzing the particles by the apparatuses described above, being 100% by mass. The silicon-containing aluminum nitride particles preferably have a ratio of the mass of silicon of 1.5% by mass or more and 8.0% by mass or less, more preferably 1.5% by mass or more and 5.0% by mass or less, even more preferably 1.5% by mass or more and 4.0% by mass or less, still more preferably 2.0% by mass or more and 4.0% by mass or less, and particularly preferably 2.5% by mass or more and 3.5% by mass or less, relative to the total of the mass of aluminum, the mass of silicon, the mass of nitrogen, and the mass of oxygen, as obtained by analyzing the particles by the apparatuses described above, being 100% by mass.

The silicon-containing aluminum nitride particles have a ratio of the mass of oxygen denoted as X % by mass, a specific surface area of the particles, as measured by the BET method, denoted as Y m²/g, and a ratio (X/Y) of a numerical value X of the oxygen mass ratio X % by mass to a numerical value Y of the specific surface area of the particles Y m²/g of 0.40 or more and 0.85 or less, relative to the total of the mass of aluminum, the mass of silicon, the mass of nitrogen, and the mass of oxygen, as obtained by analyzing the particles by the apparatuses described above, being 100% by mass. The ratio (X/Y) is a ratio of a numerical value X of the oxygen mass ratio X % by mass in the silicon-containing aluminum nitride particles to a numerical value Y of the specific surface area Y m²/g of the silicon-containing aluminum nitride particles. When the ratio (X/Y) is 0.40 or more and 0.85 or less, the silicon-containing aluminum nitride particles have an oxygen-containing film formed on the surface while inhibiting the formation of aluminum oxide. The oxygen-containing film formed on the surface of the silicon-containing aluminum nitride particles inhibits the reaction between the silicon-containing aluminum nitride particles and moisture, and the silicon-containing aluminum nitride particles are less likely to react with moisture contained in, for example, the air or resin, thereby improving the moisture resistance of the silicon-containing aluminum nitride particles. The silicon-containing aluminum nitride particles having a ratio (X/Y) within the above range are inhibited from reacting with moisture, so that the generation of ammonia (NH₃) produced by the reaction of aluminum nitride (AlN) contained in the silicon-containing aluminum nitride particles with moisture (H₂O) can be inhibited even when contained in the resin. When the silicon-containing aluminum nitride particles are contained in the resin, deterioration of the resin due to ammonia can be inhibited. The ratio of the mass of oxygen in the silicon-containing aluminum nitride particles varies depending on the size (such as average particle diameter) of the silicon-containing aluminum nitride particles. When the silicon-containing aluminum nitride particles have a ratio (X/Y) of a numerical value X of the oxygen mass ratio X % by mass divided by a numerical value Y of the specific surface area of the particles Y m²/g, as measured by the BET method, of 0.40 or more and 0.85 or less, relative to the total of the mass of aluminum, the mass of silicon, the mass of nitrogen, and the mass of oxygen, as obtained by analyzing the particles by the apparatuses described above, being 100% by mass, even for silicon-containing aluminum nitride particles having a small average particle diameter, an oxygen-containing film capable of inhibiting the reaction between the silicon-containing aluminum nitride particles and moisture is formed on the surface of the silicon-containing aluminum nitride particles. In order to substantially uniformly form an oxygen-containing film capable of inhibiting the reaction with moisture on the surface of the silicon-containing aluminum nitride particles, the ratio (X/Y) of the silicon-containing aluminum nitride particles is preferably 0.41 or more and 0.84 or less, more preferably 0.42 or more and 0.83 or less, and even more preferably 0.43 or more and 0.82 or less. The average particle diameter of the silicon-containing aluminum nitride particles can be measured by a Fisher Sub-Sieve Sizer method (hereinafter also referred to as “FSSS method”). The silicon-containing aluminum nitride particles having a small average particle diameter refers to, for example, silicon-containing aluminum nitride particles having an average particle diameter of 3.0 μm or less as measured by the FSSS method. The silicon-containing aluminum nitride particles having a small average particle diameter may have an average particle diameter, as measured by the FSSS method, of 0.1 μm or more and 3.0 μm or less, or 0.2 μm or more and 3.0 μm or less, or 0.5 μm or more and 3.0 μm or less. The average particle diameter D measured by the FSSS method can be, for example, a Fisher Sub-Sieve Sizer's Number measured using a Fisher Sub-Sieve Sizer Model 95 (manufactured by Fisher Scientific Inc.). The FSSS method is a type of air permeability method and is a method of measuring a specific surface area by utilizing the flow resistance of air to mainly determine a particle diameter of primary particles.

When the silicon-containing aluminum nitride particles have a ratio (X/Y) of 0.40 or more and 0.85 or less, an oxygen-containing film is formed on the surface of the particles, in which the formation of aluminum oxide (Al₂O₃) by the reaction of aluminum in the silicon-containing aluminum nitride particles and oxygen is inhibited. As described above, aluminum nitride particles have high thermal conductivity, generally 150 W/m·K to 200 W/m·K at 20° C. Meanwhile, aluminum oxide particles generally have a thermal conductivity of 30 W/m·K at 20° C., which is significantly lower than that of aluminum nitride particles. When the ratio (X/Y) of the silicon-containing aluminum nitride particles is 0.40 or more and 0.85 or less, an oxygen-containing film can be formed on the surface of the particles while inhibiting the formation of aluminum oxide. When the ratio (X/Y) of the silicon-containing aluminum nitride particles is 0.40 or more and 0.85 or less, the silicon-containing aluminum nitride particles can maintain high thermal conductivity and high reflectance while inhibiting the reaction between the silicon-containing aluminum nitride particles and moisture.

When the silicon-containing aluminum nitride particles have a ratio of the total of the mass of aluminum and the mass of nitrogen of 90% by mass or more, and a ratio of the mass of silicon of 1.5% by mass or more and 10% by mass or less, relative to the total of the mass of aluminum, the mass of silicon, the mass of nitrogen, and the mass of oxygen, as obtained by analyzing the particles by the apparatuses described above, being 100% by mass, it is easier to form an oxygen-containing film while inhibiting the formation of aluminum oxide than aluminum nitride particles containing no silicon or silicon in a mass ratio of less than 1.5% by mass. The silicon-containing aluminum nitride particles can form an oxygen-containing film on the surface of the silicon-containing aluminum nitride particles while inhibiting the formation of aluminum oxide by subjecting a raw material mixture to a first heat treatment to obtain silicon-containing aluminum nitride particles, and then further subjecting the resulting silicon-containing aluminum nitride particles to a second heat treatment. The reason why the silicon-containing aluminum nitride particles can form an oxygen-containing film while inhibiting the formation of aluminum oxide than aluminum nitride particles containing no silicon or silicon in a mass ratio of less than 1.5% by mass is presumably because silicon is more easily oxidized than aluminum, and thus silicon reacts with oxygen before aluminum does to form an oxygen-containing film. For example, when aluminum nitride particles having a silicon mass ratio of less than 1.5% by mass are subjected to a second heat treatment, the amount of oxygen obtained by analyzing the particles increases, and the ratio (X/Y) becomes 1 or more, which is more than 0.85. When the ratio (X/Y) of the silicon-containing aluminum nitride particles is large as more than 1, the oxygen content relative to the specific surface area is high, and it is presumed that aluminum in the silicon-containing aluminum nitride particles reacts with oxygen to form a film containing aluminum oxide (Al₂O₃) on the surface of the silicon-containing aluminum nitride particles.

The silicon-containing aluminum nitride particles have, relative to a total of the mass of aluminum, the mass of silicon, the mass of nitrogen, and the mass of oxygen, as obtained by analyzing the particles by the apparatuses described above, being 100% by mass, a ratio of a total of the mass of aluminum and the mass of nitrogen of 90% by mass or more, and a ratio of the mass of silicon of 1.5% by mass or more and 10.0% by mass or less, wherein a ratio O^{P}/N^{P} of an oxygen atomic percentage O^{P} (atomic % (at %)) to a nitrogen atomic percentage N^{P} (at %), as obtained by analyzing the particles according to X-ray photoelectron spectroscopy (hereinafter also referred to as “XPS”), is more than 2.0. When the silicon-containing aluminum nitride particles have a ratio O^{P}/N^{P} of more than 2.0, an oxygen-containing film is formed on the surface of the silicon-containing aluminum nitride particles while inhibiting the formation of aluminum oxide. When the silicon-containing aluminum nitride particles have a ratio O^{P}/N^{P} of more than 2.0, an oxygen-containing film capable of inhibiting the reaction between the silicon-containing aluminum nitride particles and moisture is formed on the surface of the silicon-containing aluminum nitride particles, even if the silicon-containing aluminum nitride particles have a large average particle diameter. The silicon-containing aluminum nitride particles having a large average particle diameter refers to silicon-containing aluminum nitride particles having an average particle diameter of more than 3.0 μm as measured by the FSSS method. The silicon-containing aluminum nitride particles having a large average particle diameter may have an average particle diameter, as measured by the FSSS method, of more than 3.0 μm and 100 μm or less, or more than 3.0 μm and 80 μm or less, or 3.5 μm or more and 80 μm or less.

When the silicon-containing aluminum nitride particles have a ratio O^{P}/N^{P} of more than 2.0, an oxygen-containing film is formed on the surface of the silicon-containing aluminum nitride particles, and the reaction between the silicon-containing aluminum nitride particles and moisture can be inhibited, even if the silicon-containing aluminum nitride particles have a large average particle diameter as more than 3.0 μm. Silicon-containing aluminum nitride particles having an oxygen-containing film on the surface can inhibits an increase in the mass of the silicon-containing aluminum nitride particles when subjected to a pressure cooker test (hereinafter also referred to as “PCT”) described below, and are less likely to react with moisture and have excellent moisture resistance while maintaining high thermal conductivity and high reflectance. The silicon-containing aluminum nitride particles preferably have a ratio O^{P}/N^{P} of 10.0 or less, more preferably 9.0 or less, and even more preferably 8.0 or less. If the ratio O^{P}/N^{P} of the silicon-containing aluminum nitride particles is too large, aluminum in the silicon-containing aluminum nitride particles may react with oxygen to form aluminum oxide, and the silicon-containing aluminum nitride particles may not maintain high thermal conductivity. In addition, if the ratio O^{P}/N^{P} of the silicon-containing aluminum nitride particles is too large, the oxygen-containing film formed on the surface of the silicon-containing aluminum nitride particles may become too thick, resulting in a decrease in reflectance.

The silicon-containing aluminum nitride particles preferably have a ratio of the mass of oxygen of 0.9% by mass or more and 3.5% by mass or less relative to a total of the mass of aluminum, the mass of silicon, the mass of nitrogen, and the mass of oxygen, as obtained by analyzing the particles by the apparatuses described above, being 100% by mass. When the silicon-containing aluminum nitride particles have a ratio of the mass of oxygen within the above range relative to a total of the mass of aluminum, the mass of silicon, the mass of nitrogen, and the mass of oxygen, as obtained by analyzing the particles by the apparatuses described above, being 100% by mass, the ratio (X/Y) falls within the range of 0.40 or more and 0.85 or less, and it is easy to form an oxygen-containing film on the surface of the silicon-containing aluminum nitride particles while inhibiting the formation of aluminum oxide. In addition, when the silicon-containing aluminum nitride particles have a ratio of the mass of oxygen of 0.9% by mass or more and 3.5% by mass or less relative to a total of the mass of aluminum, the mass of silicon, the mass of nitrogen, and the mass of oxygen, as obtained by analyzing the particles by the apparatuses described above, being 100% by mass, the ratio O^{P}/N^{P} becomes more than 2.0, and it is easy to form an oxygen-containing film on the surface of the silicon-containing aluminum nitride particles while inhibiting the formation of aluminum oxide. The ratio of the mass of oxygen of the silicon-containing aluminum nitride particles, relative to a total of the mass of aluminum, the mass of silicon, the mass of nitrogen, and the mass of oxygen, as obtained by analyzing the particles by the apparatuses described above, being 100% by mass, is more preferably 1.0% by mass or more and 3.5% by mass or less, even more preferably 1.1% by mass or more and 3.4% by mass or less, and particularly preferably 1.2% by mass or more and 3.3% by mass or less.

The silicon-containing aluminum nitride particles can form an oxygen-containing film on the surface of the silicon-containing aluminum nitride particles while inhibiting the formation of aluminum oxide by subjecting a raw material mixture to a first heat treatment to obtain silicon-containing aluminum nitride particles, and then further subjecting the resulting silicon-containing aluminum nitride particles to a second heat treatment. The silicon-containing aluminum nitride particles obtained by heat-treating the raw material mixture may also contain oxygen on the surface due to the attachment of hydroxyl groups (OH). When the silicon-containing aluminum nitride particles, even if the ratio of the mass of oxygen is 0.9% by mass or more and 3.5% by mass or less relative to a total of the mass of aluminum, the mass of silicon, the mass of nitrogen, and the mass of oxygen, as obtained by analyzing the particles by the apparatuses described above, being 100% by mass, have no oxygen-containing film formed on the surface, the reaction between the silicon-containing aluminum nitride particles and moisture is less likely to be inhibited, and the generation of, for example, ammonia (NH₃) due to the reaction between moisture in the air or resin and components in the silicon-containing aluminum nitride particles may not be inhibited. In the silicon-containing aluminum nitride particles, even if no second heat treatment is performed and no oxygen-containing film is formed on the surface of the particles, there may be a case where hydroxyl groups (OH) are bonded to the surface of the particles and the ratio of the mass of oxygen falls within the range of 0.9% by mass or more and 3.5% by mass or less. However, if no oxygen-containing film is formed on the surface of the particles, the particle diameter becomes slightly smaller and the numerical value Y of the specific surface area Y m²/g becomes larger, and thus the ratio (X/Y) becomes small as less than 0.40 even if the mass of oxygen X % by mass is 0.9% by mass or more and 3.5% by mass or less. In the silicon-containing aluminum nitride particles, even if no second heat treatment is performed and no oxygen-containing film is formed on the surface of the particles, there may be a case where hydroxyl groups (OH) are bonded to the surface of the particles and the ratio of the mass of oxygen falls within the range of 0.9% by mass or more and 3.5% by mass or less. However, if no oxygen-containing film is formed on the surface of the particles, the ratio O^{P}/N^{P} as obtained by analyzing the particles by XPS becomes less than 2.0.

The silicon-containing aluminum nitride particles preferably have a specific surface area, as measured by the BET method, of 2.5 m²/g or more and 4.5 m²/g or less. When the specific surface area of the silicon-containing aluminum nitride particles, as measured by the BET method, is 2.5 m²/g or more and 4.5 m²/g or less, it is presumed that an oxygen-containing film is formed almost uniformly on the surface of the silicon-containing aluminum nitride particles having a ratio (X/Y) of 0.40 or more and 0.85 or less, and the reaction between the components of the silicon-containing aluminum nitride particles, especially aluminum, and moisture is inhibited, so that the generation of ammonia (NH₃) produced by the reaction of aluminum nitride (AlN) contained in the silicon-containing aluminum nitride particles with moisture (H₂O) can be inhibited even when contained in the resin. The specific surface area of the silicon-containing aluminum nitride particles, as measured by the BET method, is more preferably 2.6 m²/g or more and 4.4 m²/g or less, even more preferably 2.7 m²/g or more and 4.2 m²/g or less. The specific surface area of the silicon-containing aluminum nitride particles, as measured by the BET method, can be measured using, for example, a full automatic specific surface area analyzer (Macsorb, manufactured by Mountech Co., Ltd.).

The silicon-containing aluminum nitride particles preferably have a ratio Al^{Ka}/N^{Ka} of a peak intensity Al^{Ka} of aluminum Ka rays to a peak intensity N^{Ka} of nitrogen Ka rays, as obtained by analyzing the particles according to X-ray fluorescence spectrometry (hereinafter also referred to as “XRF”), of more than 740. The peak intensity of nitrogen Ka rays, as obtained by measuring the silicon-containing aluminum nitride particles by XRF, is the peak intensity of the Ka rays of the nitrogen element. The peak intensity of aluminum Ka rays, as obtained by measuring the silicon-containing aluminum nitride particles by XRF, is the peak intensity of the Ka rays of the aluminum element. Since the silicon-containing aluminum nitride particles are covered with an oxygen-containing film, the peak intensity N^{Ka} of the Ka rays of nitrogen, which forms the crystal structure of the silicon-containing aluminum nitride particles, is more likely to be decreased with the increase of an oxygen-containing film than the peak intensity Al^{Ka} of the Ka rays of aluminum, which is more likely to bond with oxygen than the nitrogen element. The XRF analysis of the silicon-containing aluminum nitride particles allows evaluation of the state of an oxygen-containing film covering the silicon-containing aluminum nitride particles. When the silicon-containing aluminum nitride particles have a ratio Al^{Ka}/N^{Ka} of a peak intensity Al^{Ka} of aluminum Ka rays to a peak intensity N^{Ka} of nitrogen Ka rays, as obtained by analyzing the particles by XRF, of more than 740, an oxygen-containing film is film-formed on the surface of the silicon-containing aluminum nitride particles. In the silicon-containing aluminum nitride particles, the ratio Al^{Ka}/N^{Ka} of a peak intensity Al^{Ka} of aluminum Ka rays to a peak intensity N^{Ka} of nitrogen Ka rays, as obtained by analyzing the particles by XRF, is more preferably 745 or more, even more preferably 750 or more, still more preferably 760 or more, and may be 810 or less. When the ratio Al^{Ka}/N^{Ka} obtained by analyzing the particles by XRF is 810 or less, an oxygen-containing film can be formed on the surface of the silicon-containing aluminum nitride particles while inhibiting the formation of aluminum oxide.

The silicon-containing aluminum nitride particles preferably have a composition represented by Al₁₋ₓSiₓN (where x satisfies 0.02≤x≤0.2) and contain oxygen. When the silicon-containing aluminum nitride particles have a composition represented by Al₁₋ₓSiₓN (where x satisfies 0.02≤x≤0.2), a part of aluminum in the crystal structure is substituted with silicon while maintaining the crystal structure of aluminum nitride, and thus the silicon-containing aluminum nitride particles can increase the reflectance while maintaining the high thermal conductivity that the aluminum nitride has. When the silicon-containing aluminum nitride particles have a composition represented by Al₁₋ₓSiₓN (where x satisfies 0.02≤x≤0.2) and a ratio (X/Y) of 0.40 or more and 0.85 or less, the silicon-containing aluminum nitride particles can have an oxygen-containing film on the surface and inhibits the reaction with moisture, thereby inhibiting the generation of ammonia (NH₃). When the silicon-containing aluminum nitride particles have a composition represented by Al₁₋ₓSiₓN (where x satisfies 0.02≤x≤0.2) and a ratio O^{P}/N^{P} of more than 2.0, the silicon-containing aluminum nitride particles can have an oxygen-containing film on the surface and inhibits the increase in mass of the silicon-containing aluminum nitride particles when subjected to PCT, and are less likely to react with moisture and have excellent moisture resistance while maintaining high thermal conductivity and high reflectance. The parameter x in the composition represented by Al₁₋ₓSiₓN represents the molar ratio of Si in 1 mol of the composition. The parameter x is more preferably 0.02 or more and 0.15 or less (0.02≤x≤0.15), even more preferably 0.02 or more and 0.10 or less (0.02≤x≤0.10), still more preferably 0.02 or more and 0.08 or less (0.02≤x≤0.08), still more preferably 0.02 or more and 0.07 or less (0.02≤x≤0.07), and particularly preferably 0.03 or more and 0.06 or less (0.03≤x≤0.06).

The silicon-containing aluminum nitride particles preferably have an average particle diameter, as measured by the FSSS method, of 0.1 μm or more and 100 μm or less. The silicon-containing aluminum nitride particles may have an average particle diameter, as measured by the FSSS method, of 0.5 μm or more and 3.0 μm or less, which may be silicon-containing aluminum nitride particles having a small average particle diameter. The average particle diameter, as measured by the FSSS method, of the silicon-containing aluminum nitride particles may be 0.1 μm or more and 3.0 μm or less, may be 0.2 μm or more and 3.0 μm or less, or may be 0.5 μm or more and 3.0 μm or less. The silicon-containing aluminum nitride particles may have an average particle diameter, as measured by the FSSS method, of more than 3.0 μm and 100 μm or less, which may be silicon-containing aluminum nitride particles having a large average particle diameter. The average particle diameter, as measured by the FSSS method, of the silicon-containing aluminum nitride particles may be more than 3.0 μm and 80 μm or less, may be 3.5 μm or more and 80 μm or less, may be 5.0 μm or more and 75 μm or less, or may be 10 μm or more and 70 μm or less.

The silicon-containing aluminum nitride particles having an average particle diameter, as measured by the FSSS method, of 0.5 μm or more and 3.0 μm or less have, relative to a total of a mass of aluminum and a mass of silicon, as obtained by analyzing the particles by ICP, and a mass of nitrogen and a mass of oxygen, as obtained by analyzing the particles using an oxygen/nitrogen analyzer, being 100% by mass, a ratio of a total of the mass of aluminum and the mass of nitrogen of 90% by mass or more, a ratio of the mass of silicon of 1.5% by mass or more and 10.0% by mass or less, and a ratio (X/Y) of 0.40 or more and 0.85 or less. When the silicon-containing aluminum nitride particles having a small average particle diameter, as measured by the FSSS method, of 0.5 μm or more and 3.0 μm or less have a ratio (X/Y) of 0.40 or more and 0.85 or less, it is presumed that an oxygen-containing film is formed almost uniformly on the surface of the silicon-containing aluminum nitride particles, and even when an oxygen-containing film is formed on the surface, the moisture resistance can be improved while maintaining high thermal conductivity and high reflectance. In the silicon-containing aluminum nitride particles, the reaction between the components in the silicon-containing aluminum nitride particles, especially aluminum, and moisture is inhibited, so that the generation of ammonia (NH₃) produced by the reaction of aluminum nitride (AlN) contained in the silicon-containing aluminum nitride particles with moisture (H₂O) can be inhibited even when contained in the resin, resulting in excellent moisture resistance.

The silicon-containing aluminum nitride particles having an average particle diameter, as measured by the FSSS method, of more than 3.0 μm and 100 μm or less have, relative to a total of a mass of aluminum and a mass of silicon, as obtained by analyzing the particles by ICP, and a mass of nitrogen and a mass of oxygen, as obtained by analyzing the particles using an oxygen/nitrogen analyzer, being 100% by mass, a ratio of a total of the mass of aluminum and the mass of nitrogen of 90% by mass or more, a ratio of the mass of silicon of 1.5% by mass or more and 10.0% by mass or less, and a ratio O^{P}/N^{P} of more than 2.0. When the silicon-containing aluminum nitride particles having a relatively large average particle diameter, as measured by the FSSS method, of more than 3.0 μm and 100 μm or less have a ratio O^{P}/N^{P} of more than 2.0, it is presumed that an oxygen-containing film is formed almost uniformly on the surface of the silicon-containing aluminum nitride particles even when the average particle diameter is relatively large. The silicon-containing aluminum nitride particles, even when the average particle diameter is relatively large and an oxygen-containing film is uniformly formed on the surface of the particles, can improve moisture resistance while maintaining high thermal conductivity and high reflectance. The silicon-containing aluminum nitride particles can inhibit the increase in mass of the silicon-containing aluminum nitride particles when subjected to PCT, and are less likely to react with moisture and have excellent moisture resistance.

The silicon-containing aluminum nitride particles preferably have, in a powder X-ray diffraction pattern measured using CuKa rays (1.5418 Å), a peak intensity at a diffraction angle 2θ of 43.3°±0.5° of 5% or less relative to a peak intensity at a diffraction angle 2θ of 33.2°±0.5° being 100%. The peak appearing at a diffraction angle 2θ of 33.2°±0.5° in the powder X-ray diffraction pattern of the silicon-containing aluminum nitride particles is a peak derived from the crystal structure of aluminum nitride (AlN). The peak appearing at a diffraction angle 2θ of 43.3°±0.5° in the powder X-ray diffraction pattern of the silicon-containing aluminum nitride particles is a peak derived from the crystal structure of aluminum oxide (Al₂O₃). The peak intensity at a diffraction angle 2θ of 43.3° 0.5° is 5% or less relative to the peak intensity at a diffraction angle 2θ of 33.2°±0.5° being 100% in the powder X-ray diffraction pattern of the silicon-containing aluminum nitride particles, indicating that the reaction between aluminum in the silicon-containing aluminum nitride particles and oxygen is inhibited, and that the silicon-containing aluminum nitride particles is inhibited the formation of aluminum oxide on the surface. When the silicon-containing aluminum nitride particles is inhibited the formation of aluminum oxide on the surface, the formation of aluminum oxide, which has a lower thermal conductivity than that of aluminum nitride, is inhibited, indicating that the crystal structure of aluminum nitride partially substituted with silicon, which has the high thermal conductivity of aluminum nitride, is maintained. The peak intensity at a diffraction angle 2θ of 43.3°+0.5° relative to the peak intensity at a diffraction angle 2θ of 33.2°+0.5° being 100% in the powder X-ray diffraction pattern of the silicon-containing aluminum nitride particles is more preferably 4% or less, even more preferably 3% or less; and may be 0.1% or more, may be 0.2% or more, or may be 0.5% or more. The powder X-ray diffraction patterns representing the crystal structures of aluminum nitride (AlN) and aluminum oxide (Al₂O₃) can be referred to the values of the International Center for Diffraction Data (ICDD).

The silicon-containing aluminum nitride particles preferably have a reflectance of 50% or more for light having a wavelength range of 380 nm or more and 730 nm or less. The silicon-containing aluminum nitride particles, even when they contain silicon and have an oxygen-containing film on the surface, can maintain a reflectance of 50% or more for light in the wavelength range of the visible light region while maintaining high thermal conductivity.

The silicon-containing aluminum nitride particles preferably have a reflectance of 80% or more for light having a wavelength range of 380 nm or more and 730 nm or less. Aluminum nitride particles have high thermal conductivity, generally 150 W/m·K to 200 W/m·K at 20° C. On the other hand, the reflectance of aluminum nitride in the wavelength range of the visible light region is generally low, ranging from 70% to 80%. The silicon-containing aluminum nitride particles, since a part of aluminum in the crystal structure is substituted with silicon while maintaining the crystal structure of aluminum nitride, can maintain a high reflectance of 80% or more for light in the wavelength range of the visible light region while maintaining the high thermal conductivity that the aluminum nitride particles have. In addition, the silicon-containing aluminum nitride particles maintain high thermal conductivity and high reflectance since the crystal structure of aluminum nitride partially substituted with silicon is maintained even when a thin oxygen-containing film is formed on the surface. The reflectance of the silicon-containing aluminum nitride particles for light in the wavelength range of the visible light region is more preferably 81% or more, even more preferably 82% or more. The reflectance of the silicon-containing aluminum nitride particles for light in the wavelength range of the visible light region may be 99% or less, may be 98% or less, or may be 95% or less.

The silicon-containing aluminum nitride particles preferably have a reflectance of 40% or less for light having a wavelength of 250 nm. The silicon-containing aluminum nitride particles, when the reflectance for light having a wavelength of 250 nm is 40% or less, can easily absorb light having a wavelength of 200 nm to less than 380 nm, which is the wavelength in the ultraviolet region around 250 nm, and, when dispersed, for example, in a polymer such as a resin, inhibit deterioration of the polymer containing the resin due to ultraviolet rays.

The silicon-containing aluminum nitride particles, when 1.0 g of the silicon-containing aluminum nitride particles is brought into contact with 50 mL of a boiled 6 mol/L hydrochloric acid aqueous solution, preferably have an amount of ammonia generated in the hydrochloric acid aqueous solution of 120 ppm by mass or less. The silicon-containing aluminum nitride particles can form an oxygen-containing film on the surface of the silicon-containing aluminum nitride particles while inhibiting the formation of aluminum oxide (Al₂O₃) by subjecting a raw material mixture to a first heat treatment to obtain silicon-containing aluminum nitride particles as a first heat-treated product, and then further subjecting the resulting silicon-containing aluminum nitride particles as the first heat-treated product to a second heat treatment at a temperature lower than that of the first heat treatment. There may be a case where the silicon-containing aluminum nitride particles have hydroxyl groups attached to the surface of the silicon-containing aluminum nitride particles obtained by the first heat treatment, and have an oxygen content of 0.9% by mass or more and 3.5% by mass or less. When the silicon-containing aluminum nitride particles do not have an oxygen-containing film formed on the surface and have hydroxyl groups attached, the reaction between the components (such as aluminum and nitrogen) in the silicon-containing aluminum nitride particles and moisture is not inhibited, and the reaction between aluminum, nitrogen, and moisture proceeds, which may cause the generation of ammonia (NH₃). When the silicon-containing aluminum nitride particles have an oxygen-containing film formed on the surface by the second heat treatment, the reaction between the components (such as aluminum and nitrogen) in the silicon-containing aluminum nitride particles and moisture is inhibited, and when 1.0 g of the silicon-containing aluminum nitride particles is brought into contact with 50 mL of a boiled 6 mol/L hydrochloric acid aqueous solution, the amount of ammonia generated in the hydrochloric acid aqueous solution is 120 ppm by mass or less. When 1.0 g of the silicon-containing aluminum nitride particles is brought into contact with 50 mL of a boiled 6 mol/L hydrochloric acid aqueous solution, the amount of ammonia generated in the hydrochloric acid aqueous solution is 120 ppm by mass or less, indicating that the silicon-containing aluminum nitride particles do not have hydroxyl groups attached to the surface, but rather have an oxygen-containing film formed on the surface, and that the reaction between the silicon-containing aluminum nitride particles and moisture is inhibited. The amount of ammonia generated can be measured by bringing 1.0 g of the silicon-containing aluminum nitride particles into contact with 50 mL of a boiled 6 mol/L hydrochloric acid aqueous solution, maintaining the contact for 10 minutes with stirring, filtering to obtain a filtrate, and measuring the concentration of ammonia in the hydrochloric acid aqueous solution, which is the filtrate, as the amount of ammonia generated. When 1.0 g of the silicon-containing aluminum nitride particles is brought into contact with 50 mL of a boiled 6 mol/L hydrochloric acid aqueous solution, the amount of ammonia generated in the hydrochloric acid aqueous solution is more preferably 115 ppm by mass or less, even more preferably 110 ppm by mass or less. When 1.0 g of the silicon-containing aluminum nitride particles is brought into contact with 50 mL of a boiled 6 mol/L hydrochloric acid aqueous solution, the amount of ammonia generated in the hydrochloric acid aqueous solution may be 0.5 ppm by mass or more, or may be 1.0 ppm by mass or more. Specifically, the amount of ammonia generated can be measured by referring to the method in Examples described later, wherein 1.0 g of the silicon-containing aluminum nitride particles is brought into contact with 50 mL of a 6 mol/L hydrochloric acid aqueous solution, and the amount of ammonia contained in the hydrochloric acid aqueous solution can be measured, for example, using an ion meter (manufactured by DKK-TOA Corporation).

The silicon-containing aluminum nitride particles preferably have a mass change rate of 50% by mass or less before and after a pressure cooker test (PCT) when exposed for 24 hours under conditions of 130° C. and 100% relative humidity using a pressure cooker tester. Specifically, when the mass of a sample of silicon-containing aluminum nitride particles before PCT is 100% by mass, the mass of a sample of silicon-containing aluminum nitride particles after PCT is preferably 150% by mass or less. The mass change rate of the silicon-containing aluminum nitride particles before and after PCT refers to the value calculated by subtracting 100% by mass of the mass ratio of the silicon-containing aluminum nitride particles before PCT from the mass ratio of the silicon-containing aluminum nitride particles after PCT. The mass change rate before and after PCT of 50% by mass or less indicates that even when exposed to a high temperature of 130° C. and a high relative humidity of 100%, the mass change rate is small, the reaction between the elements in the silicon-containing aluminum nitride particles and moisture is inhibited, and the moisture resistance is improved. As to the mass change rate of silicon-containing aluminum nitride particles before and after PCT, silicon-containing aluminum nitride particles having a smaller average particle diameter tend to have a larger specific surface area and a higher mass change rate. In the silicon-containing aluminum nitride particles having a small average particle diameter, as measured by the FSSS method, of 0.5 μm or more and 3.0 μm or less, the mass change rate before and after PCT is preferably 50% by mass or less, more preferably 48% by mass or less, and even more preferably 46% by mass or less. In the silicon-containing aluminum nitride particles having a large average particle diameter, as measured by the FSSS method, of more than 3.0 μm and 100 μm or less, the mass change rate before and after PCT is preferably 50% by mass or less, more preferably 10% by mass or less, even more preferably 5% by mass or less, and still more preferably 1% by mass or less.

The sintered body contains silicon-containing aluminum nitride particles. The sintered body contains silicon-containing aluminum nitride particles, and the content of the silicon-containing aluminum nitride particles may be 90% by mass or more and may be 99% by mass or less. The sintered body may be obtained by molding a raw material powder containing silicon-containing aluminum nitride particles to obtain a molded body, and then calcining the obtained molded body. The sintered body contains silicon-containing aluminum nitride particles. The silicon-containing aluminum nitride particles contained in the sintered body have, relative to a total of a mass of aluminum, a mass of silicon, a mass of nitrogen, and a mass of oxygen, as obtained by analyzing the particles by the apparatuses described above, being 100% by mass, a ratio of the mass of oxygen denoted as X % by mass, a specific surface area of the particles, as measured by the BET method, denoted as Y m²/g, and a ratio (X/Y) of a numerical value X of the oxygen mass ratio X % by mass to a numerical value Y of the specific surface area of the particles Y m²/g of 0.40 or more and 0.85 or less. The silicon-containing aluminum nitride particles contained in the sintered body have, relative to a total of a mass of aluminum, a mass of silicon, a mass of nitrogen, and a mass of oxygen, as obtained by analyzing the particles by the apparatuses described above, being 100% by mass, a ratio of a total of the mass of aluminum and the mass of nitrogen of 90% by mass or more, a ratio of the mass of silicon of 1.5% by mass or more and 10.0% by mass or less, and a ratio O^{P}/N^{P} of more than 2.0. The silicon-containing aluminum nitride particles have an oxygen-containing film on the surface, which inhibits the reaction between the silicon-containing aluminum nitride particles and moisture, thereby inhibiting the generation of ammonia (NH₃) and improving the moisture resistance. The silicon-containing aluminum nitride particles have an oxygen-containing film on the surface, which inhibits the reaction between the silicon-containing aluminum nitride particles and moisture, so that the mass change rate before and after PCT is 50% by mass or less, and the moisture resistance is improved. The sintered body containing the silicon-containing aluminum nitride particles can be used, for example, as a support for placing a light source of a light emitting device, since it has a high reflectance for light in the visible light region and improved moisture resistance while maintaining the high thermal conductivity that the aluminum nitride has. The sintered body containing the silicon-containing aluminum nitride particles can also be used as a support for heat sinks or electronic components. Examples of the method for molding a raw material containing silicon-containing aluminum nitride particles to obtain a molded body include die press molding and cold isostatic pressing (CIP) for which the term is defined in No. 2109 of JIS Z2500:2000. The atmosphere in which the molded body is calcined is preferably an inert atmosphere containing nitrogen, and the content of nitrogen gas in the inert atmosphere is preferably 70% by volume or more, or may be 80% by volume or more. The temperature at which the molded body is calcined may be 1,600° C. or higher and 1,800° C. or lower, or may be 1,650° C. or higher and 1,750° C. or lower.

The resin composition contains silicon-containing aluminum nitride particles and a resin. In the resin composition containing silicon-containing aluminum nitride particles, the silicon-containing aluminum nitride particles can be used, for example, as a filler. The resin contained in the resin composition used may be a thermoplastic resin or a thermosetting resin. The resin composition containing silicon-containing aluminum nitride particles can be used in a light emitting device, for example, as a molded body having a recessed portion and a resin portion that also functions as a reflector, or as a sealing material placed in the recessed portion of a molded body. The resin composition containing silicon-containing aluminum nitride particles can also be used as a bonding material, such as a die-bonding material for bonding a light emitting element or a semiconductor element to a support, or as an underfill material. As the resin contained in the resin composition, the thermoplastic resin used may be at least one resin selected from the group consisting of acrylic resin, polycarbonate resin, cyclic polyolefin resin, polyethylene terephthalate resin, and polyester resin. As the resin contained in the resin composition, the thermosetting resin used may be at least one resin selected from the group consisting of epoxy resin and silicone resin.

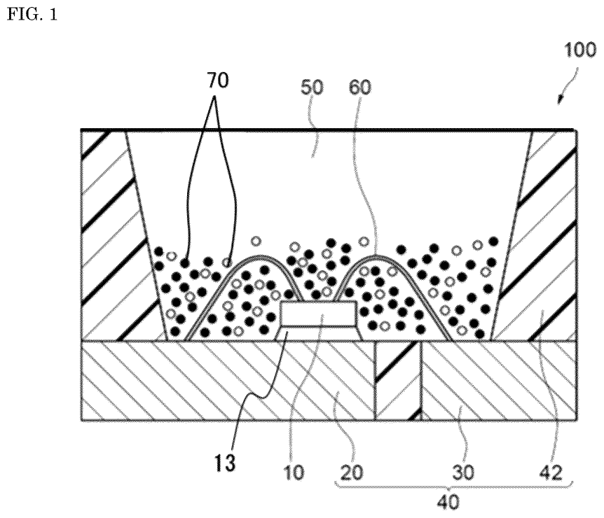

FIG. 1 is a schematic cross-sectional view showing an example of a light emitting device using a resin composition containing silicon-containing aluminum nitride particles.

A light emitting device 100 includes a molded body 40 that is a support having a recessed portion, a light emitting element 10 that serves as a light source, and a fluorescent member 50 that is disposed in the recessed portion and is a sealing material covering the light emitting element 10. The molded body 40 is formed by integrally molding a pair of leads 20 and 30 and a resin portion 42 containing a thermoplastic resin or a thermosetting resin. The pair of leads 20 and 30 constituting the bottom surface of the recessed portion and the resin portion 42 constituting the lateral surface of the recessed portion are disposed in the molded body 40. The lateral surface of the recessed portion formed by the resin portion 42 also functions as a reflector for the light emitting device. The light emitting element 10 is die-bonded by a bonding member 13 to the upper surface of one lead 20 of the pair of leads 20 and 30 constituting the bottom surface of the recessed portion of the molded body 40. The light emitting element 10 has a pair of positive and negative electrodes, and the pair of positive and negative electrodes are each electrically connected to the pair of leads 20 and 30 via a wire 60. The light emitting element 10 is covered with the fluorescent member 50. The fluorescent member 50 includes a fluorescent material 70 that converts the wavelength of light emitted by the light emitting element 10. The fluorescent material 70 may include a first fluorescent material and a second fluorescent material, each having a light emission peak wavelength in a different wavelength range.

The resin composition containing silicon-containing aluminum nitride particles is preferably contained in the resin portion constituting the molded body that is a support for the light emitting device. The silicon-containing aluminum nitride particles inhibit the reaction with moisture in the resin while maintaining a high reflectance, so that the resin composition containing silicon-containing aluminum nitride particles can inhibit the reaction between the silicon-containing aluminum nitride particles and moisture contained in the resin, thereby inhibiting the generation of ammonia (NH₃). The resin composition containing silicon-containing aluminum nitride particles can form a resin portion without inhibiting the curing of the resin composition and while inhibiting deterioration of the cured product after curing. Since the resin portion constituting the molded body for the light emitting device also functions as a reflector, the resin portion formed using the resin composition containing silicon-containing aluminum nitride particles can improve the light extraction efficiency due to the high reflectance of the silicon-containing aluminum nitride particles.

The resin composition containing silicon-containing aluminum nitride particles is preferably contained in a bonding member for die-bonding the light emitting element to one of the leads. The silicon-containing aluminum nitride particles inhibit the reaction with moisture in the resin while maintaining high thermal conductivity, so that the resin composition containing silicon-containing aluminum nitride particles can inhibit the reaction between the silicon-containing aluminum nitride particles and moisture contained in the resin, thereby inhibiting the generation of ammonia (NH₃) and improving moisture resistance by reducing the mass change rate before and after PCT to 50% or less. The resin composition containing silicon-containing aluminum nitride particles can form a resin portion without inhibiting the curing of the resin composition and while inhibiting deterioration of the cured product after curing. By using the resin composition containing silicon-containing aluminum nitride particles in the bonding member for die-bonding the light emitting element to the leads, the heat dissipation properties of the light emitting device can be improved due to the high thermal conductivity of the silicon-containing aluminum nitride particles.

The method for producing silicon-containing aluminum nitride particles includes: mixing aluminum nitride and silicon nitride to obtain a raw material mixture containing silicon nitride in an amount of 2% by mass or more and 15% by mass or less relative to a total of aluminum nitride and silicon nitride being 100% by mass; subjecting the raw material mixture to a first heat treatment at a pressure of 0.101 MPa or more and a temperature of 1,600° C. or higher and 2,100° C. or lower to obtain a first heat-treated product; and subjecting the obtained first heat-treated product to a second heat treatment at a temperature of 850° C. or higher and lower than 1,000° C. to obtain a second heat-treated product. The method for producing silicon-containing aluminum nitride particles preferably includes wet dispersing the obtained first heat-treated product prior to the second heat treatment.

In the raw material mixture, the content of silicon nitride is 2% by mass or more and 15% by mass or less, preferably 3% by mass or more and 14% by mass or less, more preferably 4% by mass or more and 13% by mass or less, even more preferably 5% by mass or more and 12% by mass or less, still more preferably 5% by mass or more and 11% by mass or less, and particularly preferably 5% by mass or more and 10% by mass or less, relative to a total amount of aluminum nitride and silicon nitride being 100% by mass. When the raw material mixture contains silicon nitride in an amount of 2% by mass or more and 15% by mass or less relative to a total amount of aluminum nitride and silicon nitride being 100% by mass, the first heat treatment can be performed to obtain a first heat-treated product in which a part of aluminum in the crystal structure is substituted with silicon while maintaining the crystal structure of aluminum nitride, and which has a high reflectance for light in the wavelength range of 380 nm or more and 730 nm or less.

The mixing of aluminum nitride and silicon nitride is preferably performed using a mixing machine. In addition to a ball mill, which is commonly used in industry, a vibration mill, a roll mill, or a jet mill can also be used as a mixing machine. In order to regulate the specific surface area of the particles within a certain range, aluminum nitride and silicon nitride can be classified using a wet separator such as a sedimentation tank, a hydrocyclone, or a centrifugal separator, or a dry classifier such as a cyclone or an air separator, which are commonly used in industry.

The resulting raw material mixture is subjected to a first heat treatment at a pressure of 0.101 MPa or more and a temperature of 1,600° C. or higher and 2,100° C. or lower to obtain a first heat-treated product. The first heat treatment can be performed to obtain a first heat-treated product as the silicon-containing aluminum nitride particles in which a part of aluminum in the crystal structure is substituted with silicon while maintaining the crystal structure of aluminum nitride.

The raw material mixture is preferably subjected to a first heat treatment under a pressure of 0.101 MPa or more and within a range of more than 0.101 MPa and 1 MPa or less. By subjecting the raw material mixture to a first heat treatment under a pressure of 0.101 MPa or more, the crystal structure of aluminum nitride is not easily destroyed even if a part of aluminum in the crystal structure of aluminum nitride is substituted with silicon, and the crystal structure of aluminum nitride having high thermal conductivity is maintained, thereby obtaining a first heat-treated product as the silicon-containing aluminum nitride particles.

The temperature of the first heat treatment is 1,600° C. or higher and 2,100° C. or lower, preferably 1,650° C. or higher and 2,050° C. or lower, more preferably 1,700° C. or higher and 2,050° C. or lower, and even more preferably 1,750° C. or higher and 2,000° C. or lower. When the temperature of the first heat treatment is 1,600° C. or higher and 2,100° C. or lower, a part of aluminum in the crystal structure can be substituted with silicon while maintaining the crystal structure of aluminum nitride, thereby obtaining silicon-containing aluminum nitride particles having a high reflectance for light in the wavelength range of 380 nm or more and 730 nm or less while maintaining the high thermal conductivity of aluminum nitride.

The atmosphere for the first heat treatment is preferably a nitrogen atmosphere. In the atmosphere for the first heat treatment, the content of nitrogen gas in the atmosphere may be 80% by volume or more, preferably 90% by volume or more, more preferably 95% by volume or more, even more preferably 98% by volume or more, and most preferably 100% by volume. The atmosphere for the first heat treatment may contain 15% by volume or less of oxygen. However, the presence of oxygen oxidizes aluminum and changes the crystal structure, making it difficult to maintain high thermal conductivity. The lower content of oxygen gas in the atmosphere enables obtaining silicon-containing aluminum nitride particles having a high reflectance while maintaining high thermal conductivity. The content of oxygen gas in the atmosphere for the first heat treatment is preferably 10% by volume or less, more preferably 5% by volume or less, and even more preferably 1% by volume or less.

The time for performing the first heat treatment, specifically, the time for which the raw material mixture is held at the heat treatment temperature, is preferably 1 hour or more and 10 hours or less, more preferably 2 hours or more and 8 hours or less. When the holding time of the raw material mixture at the first heat treatment temperature is 1 hour or more and 10 hours or less, a part of aluminum in the crystal structure can be substituted with silicon while maintaining the crystal structure of aluminum nitride, thereby obtaining silicon-containing aluminum nitride particles having a high reflectance for light in the wavelength range of the visible light region while maintaining the high thermal conductivity that the aluminum nitride has.

In the method for producing silicon-containing aluminum nitride particles, obtaining a raw material mixture and first heat-treating the raw material mixture to obtain a first heat-treated product may be referenced the disclosure of Japanese Unexamined Patent Publication No. 2020-100543.

The resulting first heat-treated product is preferably wet-dispersed prior to the second heat treatment. By wet-dispersing the resulting first heat-treated product prior to the second heat treatment, the first heat-treated product agglomerated into secondary particles during the first heat treatment can be dispersed into individual primary particles and then subjected to the second heat treatment after the wet dispersion, so that an oxygen-containing film can be formed uniformly on the surface of the primary particles by the second heat treatment. The wet dispersion can be performed by dispersing the resulting first heat-treated product in a solvent having a mass (g) that is 2 to 5 times the mass (g) of the first heat-treated product, and stirring the mixture. The solvent used in the wet dispersion may be, for example, at least one selected from the group consisting of water, methanol, ethanol, isopropyl alcohol, n-butyl alcohol, propylene glycol, diethyl ether, dimethyl ether, ethyl methyl ether, ethylene glycol, methyl ethyl ketone, cyclohexane, cyclohexanone, n-hexane, toluene, benzene, acetone, chloroform, dimethylformamide, and dichloromethane. The solvent may be used alone or in a mixture of two or more solvents. The solvent preferably contains at least one of water and ethanol, more preferably water. The water may be deionized water. The temperature of the solvent when performing the wet dispersion is preferably room temperature, and is preferably 15° C. or higher and 25° C. or lower. In order to disperse the first heat-treated product agglomerated into secondary particles so as to contain a large amount of primary particles, the time for wet-dispersing the first heat-treated product is preferably 0.5 hours or more and 10 hours or less, more preferably 1 hour or more and 8 hours or less. The wet dispersion can also be performed using, for example, a mixing machine, or by stirring using, for example, a ball mill. In the case of a ball mill, the media may be, for example, alumina balls having a diameter (φ) of 1 mm or more and 5 mm or less.

The method for producing silicon-containing aluminum nitride particles preferably includes: subjecting the first heat-treated product to solid-liquid separation after wet dispersion; and drying the product in a temperature range of 80° C. or higher and 120° C. or lower. By subjecting the first heat-treated product to solid-liquid separation after wet dispersion, followed by drying in a temperature range of 80° C. or higher and 120° C. or lower, the first heat-treated product formed into primary particles by the wet dispersion can be dried in the form of primary particles, which facilitates the formation of an oxygen-containing film on the surface of each particle. The temperature for drying the first heat-treated product after wet dispersion may be 90° C. or higher and 110° C. or lower.

The first heat-treated product after wet dispersion preferably has a particle diameter ratio D/Dm of an average particle diameter D, as measured by the FSSS method, to a volume median diameter Dm, as measured by the laser diffraction particle size distribution measurement method, of 0.2 or more and 0.95 or less. The first heat-treated product after wet dispersion is preferably dried after solid-liquid separation. When the first heat-treated product after wet dispersion has a particle diameter ratio D/Dm of 0.2 or more and 0.95 or less, the average particle diameter of the first heat-treated product after wet dispersion, as measured by the FSSS method, is preferably 0.1 μm or more and 100 μm or less. The volume median diameter Dm measured by the laser diffraction particle size distribution measurement method is a volume median diameter where the cumulative frequency is 50% in the volume-based particle size distribution measured by the laser diffraction particle size distribution measurement method. The laser diffraction particle size distribution measurement method is a method of measuring particle sizes by utilizing scattered laser light irradiated on particles without distinguishing between primary and secondary particles. The volume median diameter Dm after wet dispersion is preferably 0.2 μm or more and 200 μm or less, more preferably 0.5 μm or more and 180 μm or less. The closer the particle diameter ratio D/Dm of the average particle diameter D to the volume median diameter Dm is to 1, the smaller the number of agglomerated secondary particles contained and the larger the number of primary particles contained. A particle diameter ratio D/Dm of less than 1 indicates that secondary particles are contained. The particle diameter ratio D/Dm of the first heat-treated product after wet dispersion being 0.2 or more and 0.5 or less indicates that the wet dispersion after the first heat treatment disperses the agglomerated secondary particles and increases the proportion of contained primary particles.

The first heat-treated product after wet dispersion preferably has a particle diameter ratio D/Dm of 0.2 or more and 0.5 or less. When the first heat-treated product after wet dispersion has a particle diameter ratio D/Dm of 0.2 or more and 0.5 or less, the average particle diameter of the first heat-treated product after wet dispersion, as measured by the FSSS method, may be 0.1 μm or more and 3.0 μm or less, or may be 0.5 μm or more and 3.0 μm or less. When the first heat-treated product after wet dispersion has a particle diameter ratio D/Dm of 0.2 or more and 0.5 or less, the volume median diameter Dm of the first heat-treated product after wet dispersion, as measured by the laser diffraction particle size distribution measurement method, may be 0.3 μm or more and 6.0 μm or less, or may be 0.5 μm or more and 5.0 μm or less. When the first heat-treated product after wet dispersion has a particle diameter ratio D/Dm of 0.2 or more and 0.5 or less, even if the average particle diameter D, as measured by the FSSS method, is small as 0.1 μm or more and 3.0 μm or less, the proportion of contained primary particles is high, and by the second heat treatment described below, an oxygen-containing film can be formed on the surface of the silicon-containing aluminum nitride particles while maintaining the crystal structure of the silicon-containing aluminum nitride particles and inhibiting the formation of aluminum oxide. The particle diameter ratio D/Dm of the first heat-treated product after wet dispersion is more preferably 0.25 or more and 0.5 or less, even more preferably 0.30 or more and 0.45 or less.

The first heat-treated product after wet dispersion preferably has a particle diameter ratio D/Dm of 0.55 or more and 0.95 or less. When the first heat-treated product after wet dispersion has a particle diameter ratio D/Dm of 0.55 or more and 0.95 or less, the average particle diameter of the first heat-treated product after wet dispersion, as measured by the FSSS method, may be more than 3.0 μm and 100 μm or less, may be more than 3.0 μm and 80 μm or less, may be 3.5 μm or more and 80 μm or less, may be 5.0 μm or more and 75 μm or less, or may be 10 μm or more and 70 μm or less. When the first heat-treated product after wet dispersion has a particle diameter ratio D/Dm of 0.55 or more and 0.95 or less, the volume median diameter Dm of the first heat-treated product after wet dispersion, as measured by the laser diffraction particle size distribution measurement method, may be 5 μm or more and 105 μm or less, or may be 6 μm or more and 100 μm or less. When the first heat-treated product after wet dispersion has a particle diameter ratio D/Dm of 0.55 or more and 0.95 or less, even if the average particle diameter D, as measured by the FSSS method, is large as more than 3.0 μm and 100 μm or less, the proportion of contained primary particles is even high, and by the second heat treatment described below, an oxygen-containing film can be formed on the surface of the silicon-containing aluminum nitride particles having a large average particle diameter while maintaining the crystal structure of the silicon-containing aluminum nitride particles and inhibiting the formation of aluminum oxide. The particle diameter ratio D/Dm of the first heat-treated product after wet dispersion is more preferably 0.6 or more and 0.9 or less, even more preferably 0.65 or more and 0.85 or less.

The resulting first heat-treated product is subjected to a second heat treatment at a temperature of 850° C. or higher and lower than 1,000° C. to obtain a second heat-treated product. The first heat-treated product can be subjected to a second heat treatment to obtain a second heat-treated product as the silicon-containing aluminum nitride particles having an oxygen-containing film formed on the surface of the first heat-treated product as the silicon-containing aluminum nitride particles while inhibiting the formation of aluminum oxide. The oxygen-containing film formed on the surface of the silicon-containing aluminum nitride particles by the second heat treatment is different from the hydroxyl groups (OH) attached to the surface of the silicon-containing aluminum nitride particles, which inhibits the reaction between the silicon-containing aluminum nitride particles and moisture and is less likely to react with moisture, for example, in the air or contained in a resin, thereby improving the moisture resistance of the silicon-containing aluminum nitride particles. The temperature of the second heat treatment is more preferably 900° C. or higher and 980° C. or lower. The temperature of the second heat treatment is lower than that of the first heat treatment, and the difference between the temperature of the first heat treatment and the temperature of the second heat treatment is preferably 500° C. or higher, more preferably 700° C. or higher; and preferably 1,250° C. or lower.

The atmosphere for the second heat treatment is preferably an air atmosphere. The air atmosphere refers to an atmosphere containing 20% by volume or more of oxygen. The pressure of the second heat treatment is preferably 0.09 MPa or more and 0.12 MPa or less, and is preferably 0.101 MPa, which is the standard atmospheric pressure.

The time for performing the second heat treatment is preferably 0.5 hours or more and 20 hours or less, more preferably 1 hour or more and 15 hours or less. The time for performing the second heat treatment refers specifically to the holding time of the first heat-treated product at the second heat treatment temperature. When the time for performing the second heat treatment is 0.5 hours or more and 20 hours or less, the crystal structure of the silicon-containing aluminum nitride particles is maintained, and an oxygen-containing film can be formed on the surface of the silicon-containing aluminum nitride particles while inhibiting the formation of aluminum oxide.

The resulting second heat-treated product may be subjected to a classification treatment. As the classification treatment, for example, at least one of wet dispersion, wet sieving, dewatering, drying, and dry sieving may be performed.

The resulting second heat-treated product is silicon-containing aluminum nitride particles having an oxygen-containing film on the surface. The resulting second heat-treated product is preferably silicon-containing aluminum nitride particles having, relative to a total of a mass of aluminum and a mass of silicon, as obtained by analyzing the particles by ICP, and a mass of nitrogen and a mass of oxygen, as obtained by analyzing the particles using an oxygen/nitrogen analyzer, being 100% by mass, a ratio of a total of the mass of aluminum and the mass of nitrogen of 90% by mass or more, a ratio of the mass of silicon of 1.5% by mass or more and 10.0% by mass or less, a ratio of the mass of oxygen denoted as X % by mass, a specific surface area of the particles, as measured by the BET method, denoted as Y m²/g, and a ratio (X/Y) of a numerical value X of the oxygen mass ratio X % by mass to a numerical value Y of the specific surface area Y m²/g of 0.40 or more and 0.85 or less.

The resulting second heat-treated product is preferably silicon-containing aluminum nitride particles having, relative to a total of a mass of aluminum and a mass of silicon, as obtained by analyzing the particles by ICP, and a mass of nitrogen and a mass of oxygen, as obtained by analyzing the particles using an oxygen/nitrogen analyzer, being 100% by mass, a ratio of a total of the mass of aluminum and the mass of nitrogen of 90% by mass or more, a ratio of the mass of silicon of 1.5% by mass or more and 10.0% by mass or less, and a ratio O^{P}/N^{P} of the oxygen atomic percentage O^{P} (at %) to the nitrogen atomic percentage N^{P} (at %), as obtained by analyzing the particles by XPS, of more than 2.0.

### EXAMPLES

The present disclosure is hereunder specifically described with reference to the following Examples. The present disclosure is not limited to the following Examples.

### Example 1

A raw material mixture was obtained by mixing 94.5% by mass of aluminum nitride powder and 5.5% by mass of silicon nitride powder, relative to a total of aluminum nitride powder and silicon nitride powder being 100% by mass.

The resulting raw material mixture was filled into a container whose material was made of boron nitride. The raw material mixture filled in the container was subjected to a first heat treatment at 1,800° C. for 4 hours under a pressure of 0.92 MPa in a nitrogen atmosphere with 100% by volume of nitrogen gas to obtain a first heat-treated product.

The resulting first heat-treated product in an amount of 100 g was dispersed in 400 g of deionized water, and then wet-dispersed at room temperature of 20° C. for 6 hours in a ball mill using 200 g of alumina balls having a diameter (φ) of 2 mm.

The first heat-treated product after wet dispersion was subjected to solid-liquid separation and dried at 100° C. for 10 hours.

The first heat-treated product after wet dispersion and drying was subjected to a second heat treatment at 900° C. for 10 hours under atmospheric pressure (0.101 MPa) in an air atmosphere to obtain a second heat-treated product.

The second heat-treated product was subjected to a classification treatment by dry sieving to obtain silicon-containing aluminum nitride particles as the second heat-treated product.

The presence or absence of silicon nitride (Si₃N₄) in the raw material mixture, the first heat treatment temperature, the wet dispersion time, the average particle diameter D of the first heat-treated product after wet dispersion and drying measured by the Fisher Sub-Sieve Sizer method, the volume median diameter Dm measured by the laser diffraction particle size distribution measurement method, the particle diameter ratio D/Dm of the average particle diameter D to the volume median diameter Dm, the second heat treatment temperature and time, and the presence or absence of a SiO₂ film attached to the surface of the second heat-treated product are shown in Table 1. In Table 1, if there is no silicon nitride (Si₃N₄) in the raw material mixture, if there is no coating layer containing silicon dioxide (SiO₂), or if no specific treatment is performed, the column is marked “absent” or “n/a”.

### Examples 2 to 5

Silicon-containing aluminum nitride particles as the second heat-treated products were obtained in the same or similar manner as in Example 1, except that the first heat treatment temperature, the wet dispersion time, and the second heat treatment temperature and time were changed as shown in Table 1.

### Comparative Example 1

The aluminum nitride particles used as raw materials in Example 1 were used as aluminum nitride particles according to Comparative Example 1.

### Comparative Example 2

The aluminum nitride powder according to Comparative Example 1 was subjected to a first heat treatment at the first heat treatment temperature shown in Table 1 in the same or similar manner as in Example 1 to obtain a first heat-treated product.

The resulting first heat-treated product was wet-dispersed for the time shown in Table 1, and wet-dispersed and dried in the same or similar manner as in Example 1.

The first heat-treated product after wet dispersion and drying was subjected to a second heat treatment at the second heat treatment temperature and time shown in Table 1 in the same or similar manner as in Example 1 to obtain a second heat-treated product.

The resulting second heat-treated product was subjected to a classification treatment in the same or similar manner as in Example 1 to obtain aluminum nitride particles according to Comparative Example 2 as the second heat-treated product.

### Comparative Example 3

The first heat-treated product after wet dispersion and drying obtained in the same or similar manner as in Example 1, except that the second heat treatment was not performed, was obtained as silicon-containing aluminum nitride particles according to Comparative Example 3.

### Comparative Example 4

Silicon-containing aluminum nitride particles as the second heat-treated product were obtained in the same or similar manner as in Example 1, except that the wet dispersion time of the first heat-treated product, and the second heat treatment temperature and time were changed as shown in Table 1.

### Comparative Example 5

A coating layer containing silicon dioxide (SiO₂) was formed on the surface of the first heat-treated product after wet dispersion and drying obtained in the same or similar manner as in Example 1, except that the second heat treatment was not performed. Specifically, 10.4 g of an ethanol solution of tetraethoxysilane (Si(OC₂H₅)₄) (tetraethoxysilane concentration of 28% by mass) was used as a solution containing a metal alkoxide. The solution containing a metal alkoxide contained tetraethoxysilane having 3.0% by mass of SiO₂ relative to 100% by mass of the first heat-treated product. A reaction solution was prepared by mixing 180 mL of an alcohol preparation (Solmix AP-7) containing ethanol, 1-propanol, and 2-propanol, and 63 mL of ammonia water containing 11.0% by mass of ammonia as a basic catalyst. The first heat-treated product after wet dispersion and drying obtained in the same or similar manner as in Example 1 in an amount of 100 g was added to the reaction solution, and the mixture was stirred at room temperature to disperse the first heat-treated product. While stirring the reaction solution, the solution containing a metal alkoxide was added dropwise to the reaction solution over 150 minutes. After the dropwise addition of the solution containing a metal alkoxide was completed, the reaction solution was stirred for 60 minutes to bring the first heat-treated product into contact with the solution containing a metal alkoxide in the presence of ammonia as a basic catalyst. The stirring was then stopped, and the first heat-treated product having a Si-containing coating layer formed on the surface was taken out of the reaction solution and dried in a dryer at a temperature of 60° C. or higher and lower than 120° C. for 15 hours or more to form a coating layer containing silicon dioxide (SiO₂) on the surface of the first heat-treated product, thereby obtaining silicon-containing aluminum nitride particles according to Comparative Example 5. The content of the coating layer was determined by: measuring the contents (% by mass) of Si and O in the silicon-containing aluminum nitride particles according to Comparative Example 5, as obtained by the composition analysis described below, and the contents (% by mass) of Si and O in the silicon-containing aluminum nitride particles according to Comparative Example 3 as the first heat-treated product before forming the coating layer; comparing the total of the contents (% by mass) of Si and G in the silicon-containing aluminum nitride particles according to Comparative Example 3 with the total of the contents (% by mass) of Si and O in the silicon-containing aluminum nitride particles according to Comparative Example 5; and calculating the increase relative to the total amount of the silicon-containing aluminum nitride particles according to Comparative Example 5 as the content of the coating layer. The content of the coating layer in the silicon-containing aluminum nitride particles according to Comparative Example 5 was 0.8% by mass relative to 100% by mass of the silicon-containing aluminum nitride particles according to Comparative Example 5.

### Average Particle Diameter D

For the first heat-treated product after wet dispersion and drying according to each of Examples and Comparative Examples, the average particle diameter was determined using a Fisher Sub-Sieve Sizer model 95 (manufactured by Fisher Scientific Inc.). Specifically, the particles in an amount of 1 cm³ were weighed to be a sample, the sample was packed in a dedicated tubular container, followed by the flow of dry air at a constant pressure, and the average particle diameter was determined from the relational formula of the transmitted atmospheric pressure and the void ratio of the packed sample by the FSSS method. The results are shown in Table 1. The average particle diameter determined by the FSSS method is also referred to as Fisher Sub-Sieve Sizer's number.

### Volume Median Diameter Dm

For the first heat-treated product after wet dispersion and drying according to each of Examples and Comparative Examples, the volume median diameter Dm was measured using a laser diffraction particle size distribution measurement apparatus (Mastersizer 3000, manufactured by Malvern Panalytical Ltd.) by the laser diffraction particle size distribution measurement method. The results are shown in Table 1.

TABLE 1

| | | | | Average | Volume | | Second heat treatment | | |
|---|---|---|---|---|---|---|---|---|---|
| | Silicon nitride | First heat | Wet | particle | median | Particle | Second heat | Second heat | |
| | (Si₃N₄) in raw | treatment | dispersion | diameter | diameter | diameter | treatment | treatment | Silicon |
| | material | temperature | time | D | Dm | ratio | temperature | time | dioxide |
| | mixture | (° C.) | (h) | (μm) | (μm) | (D/Dm) | (° C.) | (h) | (SiO₂) |
| Example 1 | present | 1800 | 6 | 0.9 | 2.1 | 0.429 | 900 | 10 | absent |
| Example 2 | present | 2030 | 6 | 1.6 | 3.3 | 0.485 | 900 | 10 | absent |
| Example 3 | present | 1800 | 1 | 1.1 | 2.8 | 0.393 | 900 | 1 | absent |
| Example 4 | present | 1800 | 1 | 1.1 | 2.9 | 0.379 | 900 | 10 | absent |
| Example 5 | present | 1800 | 1 | 1.1 | 3.5 | 0.314 | 950 | 15 | absent |
| Comparative | absent | n/a | n/a | 0.8 | 2.1 | 0.381 | n/a | n/a | absent |
| Example 1 | | | | | | | | | |
| Comparative | absent | 1800 | 4 | 1.1 | 3.2 | 0.344 | 900 | 10 | absent |
| Example 2 | | | | | | | | | |
| Comparative | present | 1800 | 6 | 0.9 | 1.8 | 0.500 | n/a | n/a | absent |
| Example 3 | | | | | | | | | |
| Comparative | present | 1800 | 1 | 1.1 | 2.8 | 0.393 | 750 | 10 | absent |
| Example 4 | | | | | | | | | |
| Comparative | present | 1800 | 6 | 0.9 | 1.8 | 0.500 | n/a | n/a | present |
| Example 5 | | | | | | | | | |

The silicon-containing aluminum nitride particles according to each of Examples 1 to 5 and Comparative Examples 3 to 5, and the aluminum nitride particles according to each of Comparative Examples 1 and 2 were subjected to the following evaluations. The results are shown in Table 2.

### Composition Analysis

The silicon-containing aluminum nitride particles according to each of Examples 1 to 5 and Comparative Examples 3 to 5, and the aluminum nitride particles according to each of Comparative Examples 1 and 2 were subjected to composition analysis. The mass of aluminum (Al) and the mass of silicon (Si) in each of the particles were quantitatively analyzed using an inductively coupled plasma-atomic emission spectroscope (ICP-AES, manufactured by PerkinElmer Inc.). The mass of oxygen (O) and the mass of nitrogen (N) in each of the particles were quantitatively analyzed using an oxygen/nitrogen analyzer (manufactured by HORIBA, Ltd.). The numerical values of Al, Si, O, and N in Table 2 are the mass ratios of the elements when the total of the mass of aluminum, the mass of silicon, the mass of nitrogen, and the mass of oxygen is 100% by mass. Each of the silicon-containing aluminum nitride particles had a composition represented by Al₁₋ₓSiₓN and contained oxygen, and the parameter x representing the molar ratio of Si was determined relative to the molar ratio of N in 1 mol of the composition being 1. The silicon-containing aluminum nitride particles according to each of Examples 1 to 5 and Comparative Examples 3 and 4 had a parameter x of 0.05 (x=0.05) in the composition represented by Al₁₋ₓSiₓN, had a composition represented by Al_{0.95}Si_{0.05}N, and contained oxygen. The aluminum nitride particles according to each of Comparative Examples 1 and 2 had a molar ratio of silicon of 0 and a composition represented by AlN. The silicon-containing aluminum nitride particles according to Comparative Example 5 had a parameter x of 0.06 (x=0.06) in the composition represented by Al₁₋ₓSiₓN, had a composition represented by Al_{0.94}Si_{0.06}N, and contained oxygen.

### Specific Surface Area by BET Method

For the silicon-containing aluminum nitride particles according to each of Examples 1 to 5 and Comparative Examples 3 to 5, and the aluminum nitride particles according to each of Comparative Examples 1 and 2, the specific surface area was measured using a full automatic specific surface area analyzer (Macsorb, manufactured by Mountech Co., Ltd.) by the BET method.

### Ratio (X/Y)

For the silicon-containing aluminum nitride particles according to each of Examples 1 to 5 and Comparative Examples 3 to 5, and the aluminum nitride particles according to each of Comparative Examples 1 and 2, the ratio (X/Y) of the numerical value X of the mass of oxygen X % by mass measured by the composition analysis to the numerical value Y of the specific surface area Y m²/g measured by the BET method was determined.

### X-Ray Diffraction Pattern and Peak Intensity

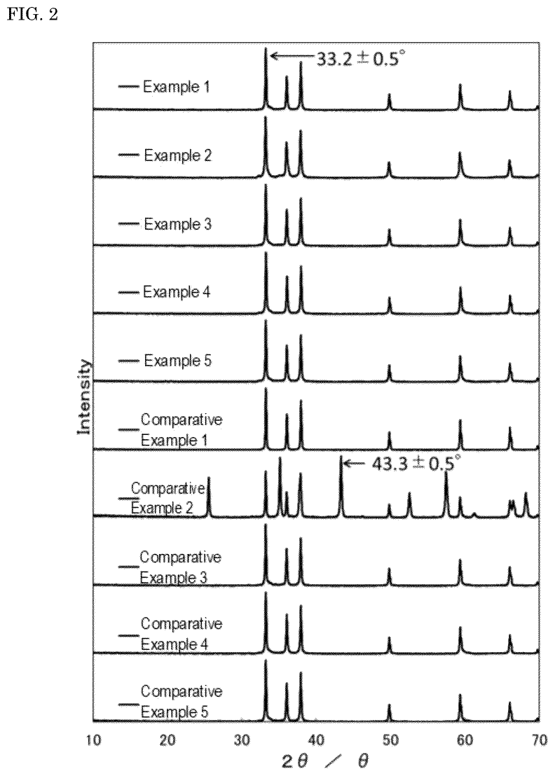

For the silicon-containing aluminum nitride particles according to each of Examples 1 to 5 and Comparative Examples 3 to 5, and the aluminum nitride particles according to each of Comparative Examples 1 and 2, the X-ray diffraction pattern was measured using a horizontal sample type multipurpose X-ray diffraction system (Ultima IV, manufactured by Rigaku Corporation) with an X-ray source of CuKa rays (λ=1.5418 Å, tube voltage of 40 kV, and tube current of 40 mA). FIG. 2 shows the X-ray diffraction pattern of the silicon-containing aluminum nitride particles according to each of Examples 1 to 5 and Comparative Examples 3 to 5, and the X-ray diffraction pattern of the aluminum nitride particles according to each of Comparative Examples 1 and 2. In the X-ray diffraction pattern of the silicon-containing aluminum nitride particles according to each of Examples 1 to 5 and Comparative Examples 3 to 5, and the X-ray diffraction pattern of the aluminum nitride particles according to each of Comparative Examples 1 and 2, the ratio of the peak intensity at a diffraction angle 2θ of 43.3°±0.5° to 100% of the peak intensity at a diffraction angle 2θ of 33.2°±0.5° was determined.

### Average Particle Diameter D

For the silicon-containing aluminum nitride particles according to each of Examples 1 to 5 and Comparative Examples 3 to 5, and the aluminum nitride particles according to each of Comparative Examples 1 and 2, the average particle diameter was determined using a Fisher Sub-Sieve Sizer model 95 (manufactured by Fisher Scientific Inc.). Specifically, the particles in an amount of 1 cm³ were weighed to be a sample, the sample was packed in a dedicated tubular container, followed by the flow of dry air at a constant pressure, and the average particle diameter was determined from the relational formula of the transmitted atmospheric pressure and the void ratio of the packed sample by the FSSS method.

### Reflectance Spectrum

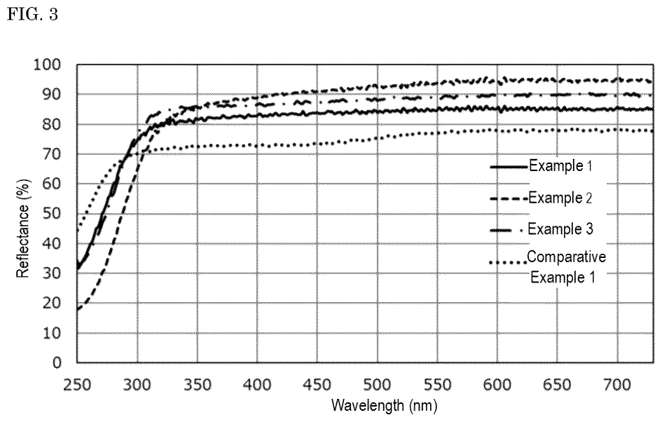

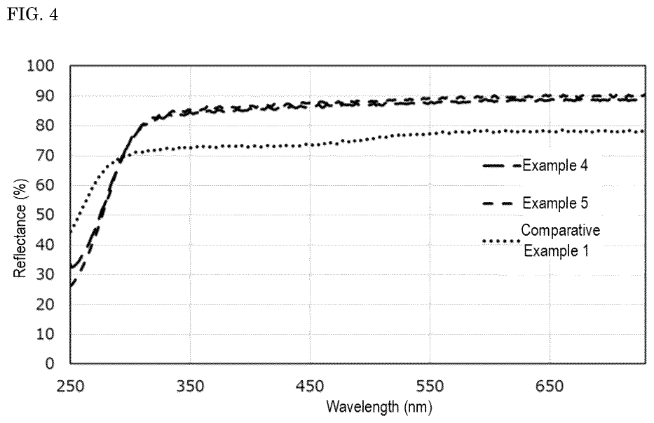

For the silicon-containing aluminum nitride particles according to each of Examples 1 to 5 and Comparative Examples 3 to 5, and the aluminum nitride particles according to each of Comparative Examples 1 and 2, using a fluorospectrophotometer (F-7100, manufactured by Hitachi High-Tech Corporation), light emitted from a halogen lamp as an excitation light source was irradiated onto the silicon-containing aluminum nitride particles or the aluminum nitride particles as a sample at room temperature (25° C.±5° C.), and both wavelengths of the excitation side and fluorescence side of the fluorospectrophotometer were scanned to measure the reflectance spectrum within the wavelength range of 250 nm or more and 730 nm or less. Using a standard reflector (Spectralon (registered trademark), manufactured by Labsphere), the reflectance of each of the silicon-containing aluminum nitride particles or the aluminum nitride particles was determined as the relative reflectance with respect to the reflectance of the standard reflector for excitation light having an excitation wavelength of 450 nm. FIG. 3 shows the reflectance spectrum of the silicon-containing aluminum nitride particles according to each of Examples 1 to 3 and the reflectance spectrum of the aluminum nitride particles according to Comparative Example 1. FIG. 4 shows the reflectance spectrum of the silicon-containing aluminum nitride particles according to each of Examples 4 and 5 and the reflectance spectrum of the aluminum nitride particles according to Comparative Example 1. The reflectances at 250 nm, 380 nm, 450 nm, and 730 nm of the silicon-containing aluminum nitride particles according to each of Examples 1 to 5 and Comparative Examples 3 to 5, and the aluminum nitride particles according to each of Comparative Examples 1 and 2 are also shown in Table 2.

### Ammonia (NH₃) Generation Amount (Ppm by Mass)

For the silicon-containing aluminum nitride particles according to each of Examples 1 to 5 and Comparative Examples 3 to 5, and the aluminum nitride particles according to each of Comparative Examples 1 and 2, 1.0 g of the silicon-containing aluminum nitride particles or the aluminum nitride particles was brought into contact with 50 mL of a 6 mol/L hydrochloric acid aqueous solution, and the amount of ammonia generated in the hydrochloric acid aqueous solution was measured.

Specifically, the measurement was performed by the following method.
(1) To 1.0 g of the silicon-containing aluminum nitride particles, 50 mL of a boiled 6 mol/L hydrochloric acid (HCl) aqueous solution was added.
(2) The silicon-containing aluminum nitride particles were brought into contact with the hydrochloric acid aqueous solution for 10 minutes while stirring at 450 rpm using a stirrer.
(3) The hydrochloric acid aqueous solution after stirring was filtered to separate the silicon-containing aluminum nitride particles, and the ammonium ion concentration (volume concentration mg/L) in the hydrochloric acid aqueous solution obtained by filtration was measured as the ammonia generation amount (ppm by mass) using an ion meter (MM-60R, manufactured by DKK-TOA Corporation).

### SEM Micrograph

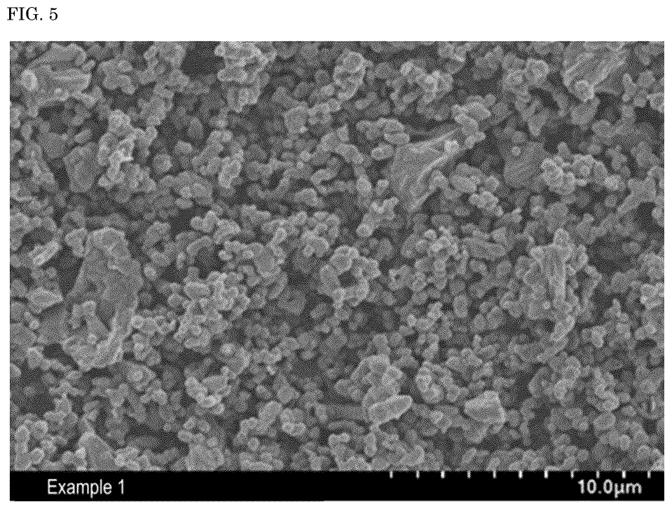

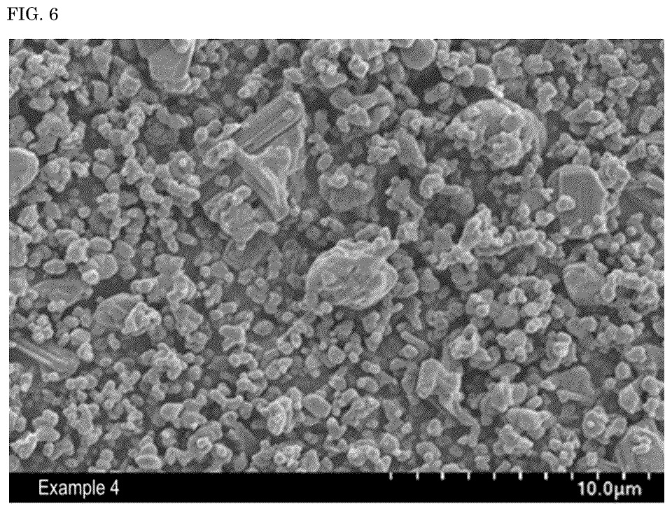

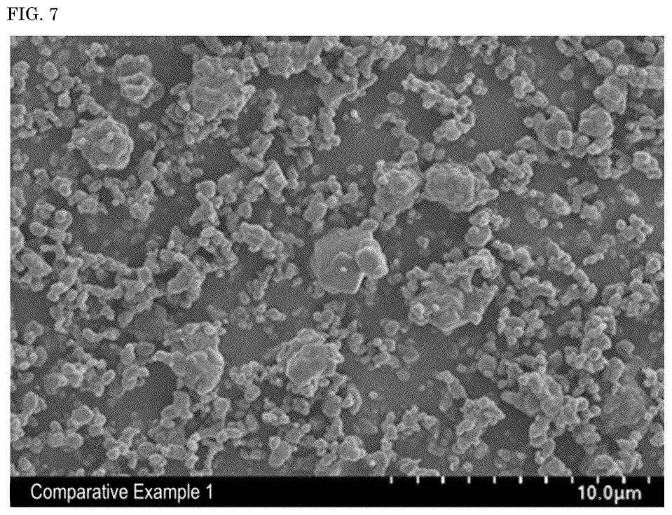

Using a scanning electron microscope (SEM), SEM micrographs were obtained for the silicon-containing aluminum nitride particles according to each of Examples 1 to 5 and Comparative Examples 3 to 5, and the aluminum nitride particles according to each of Comparative Examples 1 and 2. FIG. 5 is an SEM micrograph of the silicon-containing aluminum nitride particles according to Example 1. FIG. 6 is an SEM micrograph of the silicon-containing aluminum nitride particles according to Example 4. FIG. 7 is an SEM micrograph of the aluminum nitride particles according to Comparative Example 1.

TABLE 2

| | Particle analysis by ICP and | | | | Specific | | | Average | | | | | Ammonia |
|---|---|---|---|---|---|---|---|---|---|---|---|---|---|
| | oxygen/nitrogen analyzers | | | | surface | | Peak | particle | | | | | (NH₃) |
| | (% by mass) | | | | area | | intensity | diameter | | | | | generation |
| | | | O | | (m²/g) | Ratio | (43.3°/ | D | Reflectance (%) | | | | amount |
| | Al | Si | (X) | N | (Y) | (X/Y) | 33.2°) | (μm) | 250 nm | 380 nm | 450 nm | 730 nm | (ppm by mass) |
| Example 1 | 61.72 | 3.12 | 2.05 | 33.11 | 4.11 | 0.499 | 2.5 [symbol] | 0.9 | 31.9 | 82.7 | 83.8 | 85.0 | 4 |
| Example 2 | 63.06 | 3.12 | 1.56 | 32.2 [symbol] | 2.91 | 0.535 | 2.54 | 1.6 | 17.8 | 88.1 | 91.0 | 95.0 | [symbol] |
| Example 3 | 63.08 | 3.21 | 1.25 | 32.48 | 2.83 | 0.442 | 2.29 | 1.1 | 34.5 | 88.1 | 87.3 | 89.7 | 110 |
| Example 4 | 61.82 | 3.23 | 1.64 | 33.31 | 2.78 | 0.580 | 2.27 | 1.1 | 33.6 | 84.8 | 86.2 | 88.9 | 8 |
| Example 5 | 61.56 | 3.15 | 3.22 | 32.07 | 3.94 | 0.820 | 2.81 | 1.1 | 28.2 | 85.8 | 87.7 | 90.1 | 1 |
| Comparative | 65.82 | 0.002 | 0.85 | 33.32 | 3.70 | 0.230 | 1.4 [symbol] | 0.8 | 44.5 | 72.7 | 73.2 | 78.3 | [symbol] 20 |
| Example 1 | | | | | | | | | | | | | |
| Comparative | 63.71 | 0.02 | 29.84 | 8.63 | 6.70 | 4.419 | 169.54 | 1.1 | 59.2 | 83.6 | 83.7 | 84. [symbol] | 5 |
| Example 2 | | | | | | | | | | | | | |
| Comparative | 61.42 | 3.32 | 1.52 | 33.74 | 5.00 | 0.304 | 2.43 | 0.9 | 36.3 | 83.0 | 84.8 | 88.5 | 170 |
| Example 3 | | | | | | | | | | | | | |
| Comparative | 61.87 | 3.21 | 1.14 | 33.78 | 2.89 | 0.394 | 2.21 | 1.1 | 33.1 | 84.2 | 85.8 | 88.7 | 280 |
| Example 4 | | | | | | | | | | | | | |
| Comparative | 61.17 | 3.74 | 1.87 | 33.22 | 8.29 | 0.225 | 2.52 | 0.8 | 32.0 | 84.3 | 85.6 | 87.7 | 2 [symbol] 0 |
| Example 5 | | | | | | | | | | | | | |

[symbol]

indicates data missing or illegible when filed

As shown in Table 2, the silicon-containing aluminum nitride particles according to each of Examples 1 to 5 had a ratio (X/Y) of 0.40 or more and 0.85 or less, and had an oxygen-containing film formed on the surface of the silicon-containing aluminum nitride particles while inhibiting the formation of aluminum oxide.

The silicon-containing aluminum nitride particles according to each of Examples 1 to 5 had a ratio of the mass of oxygen of 0.9% by mass or more and 3.5% by mass or less relative to the total of the mass of aluminum, the mass of silicon, the mass of nitrogen, and the mass of oxygen, as obtained by analyzing the particles, being 1000% by mass, and had a specific surface area, as measured by the BET method, of 2.5 m²/g or more and 4.5 m²/g or less. The silicon-containing aluminum nitride particles according to each of Examples 1 to 5 had a composition represented by Al₁₋ₓSiₓN (x=0.05).

As shown in Table 2, the silicon-containing aluminum nitride particles according to each of Examples 1 to 5 had an ammonia generation amount of 120 ppm by mass or less, indicating that an oxygen-containing film was formed on the surface of the silicon-containing aluminum nitride particles, which inhibited the reaction between the silicon-containing aluminum nitride particles and moisture.

As shown in Table 2 and FIG. 2, the silicon-containing aluminum nitride particles according to each of Examples 1 to 5 had a peak intensity at a diffraction angle 2θ of 43.3°±0.5° of 5% or less, specifically 3% or less, relative to the peak intensity at a diffraction angle 2θ of 33.2°±0.5° being 100% in the powder X-ray diffraction pattern measured using CuKa rays (1.5418 Å), which inhibited the formation of aluminum oxide on the surface of the silicon-containing aluminum nitride particles.

As shown in Table 2 and FIGS. 3 and 4, the silicon-containing aluminum nitride particles according to each of Examples 1 to 5 maintained a high reflectance, with a reflectance of 80% or more for light in the visible light region of 380 nm or more and 730 nm or less. In addition, the silicon-containing aluminum nitride particles according to each of Examples 1 to 5 had a reflectance of 40% or less for light having a wavelength of 250 nm, indicating that the silicon-containing aluminum nitride particles easily absorbed light having a wavelength of 200 nm to less than 380 nm, which is the wavelength in the ultraviolet region around 250 nm, and, when dispersed, for example, in a polymer such as a resin, inhibited deterioration of the polymer containing the resin due to ultraviolet rays.

As shown in the SEM micrograph in FIG. 5, the silicon-containing aluminum nitride particles according to Example 1 had few agglomerated secondary particles and many primary particles, and thus it is presumed that an oxygen-containing film was uniformly formed on the surface of the primary particles.

As shown in the SEM micrograph in FIG. 6, the silicon-containing aluminum nitride particles according to Example 4 contained agglomerated secondary particles, since the first heat-treated product was wet-dispersed for 1 hour, which was shorter than the time for wet dispersing the first heat-treated product of the silicon-containing aluminum nitride particles according to Example 1.

The aluminum nitride particles according to Comparative Example 1 had a low reflectance, with a reflectance of less than 80% for light in the visible light region of 380 nm or more and 730 nm or less. In addition, the reflectance for light having a wavelength of 250 nm was more than 40%. The aluminum nitride particles according to Comparative Example 1 had a low oxygen content, and it is presumed that a small amount of oxygen was contained due to hydroxyl groups (OH) attached to the surface. The specific surface area of the aluminum nitride particles according to Comparative Example 1 was not significantly different from that of the silicon-containing aluminum nitride particles according to Example 5, but the ratio (X/Y) was 0.230, which was less than 0.40 due to the low oxygen content. The aluminum nitride particles according to Comparative Example 1 generated a large amount of ammonia with 620 ppm by mass, which was more than 120 ppm by mass, since no oxygen-containing film was formed on the surface and aluminum in the aluminum nitride reacted with moisture. The aluminum nitride particles according to Comparative Example 1, since no oxygen-containing film was formed on the surface, had a mass change rate of more than 50% before and after PCT, and thus the moisture resistance was not improved. As shown in the SEM micrograph in FIG. 7, the aluminum nitride particles according to Comparative Example 1 had few agglomerated secondary particles and many primary particles. The appearance thereof shown in the SEM micrograph was not significantly different from that of the silicon-containing aluminum nitride particles according to Example 1.

The aluminum nitride particles according to Comparative Example 2 had a reflectance of more than 40% for light having a wavelength of 250 nm. The aluminum nitride particles according to Comparative Example 2 had a relatively high reflectance for light having a wavelength of 200 nm to less than 380 nm, which is the wavelength in the ultraviolet region around 250 nm, and were less likely to absorb light in the ultraviolet region. A film containing aluminum oxide (Al₂O₃) was formed on the surface of the particles by the second heat treatment. The aluminum nitride particles according to Comparative Example 2 had a large peak intensity at a diffraction angle 2θ of 43.3°±0.5° of 169.54% relative to the peak intensity at a diffraction angle 2θ of 33.2°±0.5° being 100% in the powder X-ray diffraction pattern. The aluminum nitride particles according to Comparative Example 2 had a high oxygen content due to the formation of aluminum oxide on the surface of the particles, and had a ratio (X/Y) of 4.419, which was more than 0.85. It is presumed that the aluminum nitride particles according to Comparative Example 2 had a low thermal conductivity due to the formation of aluminum oxide on the surface.

The silicon-containing aluminum nitride particles according to Comparative Example 3 were not subjected to the second heat treatment, and thus no oxygen-containing film was formed on the surface of the particles. The silicon-containing aluminum nitride particles according to Comparative Example 3 did not have a significant increase in oxygen content, and thus it is presumed that hydroxyl groups were attached to the surface of the particles. The silicon-containing aluminum nitride particles according to Comparative Example 3, since no oxygen-containing film was formed on the surface, had a specific surface area larger than that of the silicon-containing aluminum nitride particles according to Examples 1 to 5, and had a ratio (X/Y) of 0.304, which was less than 0.40. The silicon-containing aluminum nitride particles according to Comparative Example 3 generated a large amount of ammonia with 170 ppm by mass, which was more than 120 ppm by mass, since no oxygen-containing film was formed on the surface and the silicon-containing aluminum nitride reacted with moisture.

The silicon-containing aluminum nitride particles according to Comparative Example 4 were subjected to the second heat treatment at a low temperature of 750° C., which was less than 850° C., and thus it is presumed that the oxygen-containing film formed on the surface of the silicon-containing aluminum nitride particles was very thin or the oxygen-containing film was not uniformly formed on the surface of the particles. The silicon-containing aluminum nitride particles according to Comparative Example 4 had an oxygen content lower than that of the silicon-containing aluminum nitride particles according to Comparative Example 3, and had a ratio (X/Y) of 0.394, which was less than 0.40. The silicon-containing aluminum nitride particles according to Comparative Example 4 generated a large amount of ammonia with 280 ppm by mass, which was more than 120 ppm by mass, since the oxygen-containing film formed on the surface was very thin or the oxygen-containing film was not uniformly formed, and aluminum in the silicon-containing aluminum nitride reacted with moisture.

The silicon-containing aluminum nitride particles according to Comparative Example 5 were not subjected to the second heat treatment, and thus no oxygen-containing film was formed on the surface of the particles. The silicon-containing aluminum nitride particles according to Comparative Example 5 had a relatively large oxygen content, and thus it is presumed that hydroxyl groups were attached to the surface of the particles. The silicon-containing aluminum nitride particles according to Comparative Example 5, since no oxygen-containing film was formed on the surface, had a specific surface area larger than that of the silicon-containing aluminum nitride particles according to Examples 1 to 5, and had a ratio (X/Y) of 0.226, which was less than 0.40. The silicon-containing aluminum nitride particles according to Comparative Example 5 generated a large amount of ammonia with 260 ppm by mass, which was more than 120 ppm by mass, since no oxygen-containing film was formed on the surface and the silicon-containing aluminum nitride reacted with moisture.

The silicon-containing aluminum nitride particles according to Examples 1, 2, and 4, and the aluminum nitride particles according to Comparative Example 1 were subjected to a PCT and evaluated as follows.

### Pressure Cooker Test (PCT)

Using a highly accelerated stress test chamber (PC-422R8, manufactured by Hirayama Manufacturing Corporation), the silicon-containing aluminum nitride particles according to each of Examples 1, 2, and 4, and the aluminum nitride particles according to Comparative Example 1 were subjected to a pressure cooker test (PCT) at a temperature of 130° C. and a relative humidity of 100% for 24 hours. The mass of the sample before PCT was defined as 100% by mass, and the mass of the sample after PCT was expressed as a mass ratio relative to 100% by mass of the mass before PCT. The mass change rate (%) was calculated by subtracting 100% of the mass before PCT from the mass ratio (%) after PCT. The mass of oxygen (O) in the sample after PCT was detected by quantitative analysis using an oxygen/nitrogen analyzer (manufactured by HORIBA, Ltd.). The numerical value of the mass of oxygen (O) in the sample after PCT detected by the oxygen/nitrogen analyzer was expressed as a mass ratio (% by mass) by dividing by the numerical value of the mass of the silicon-containing aluminum nitride particles (sample) fed into the oxygen/nitrogen analyzer, and multiplying by 100.

In the silicon-containing aluminum nitride particles according to Examples 1 and 2, the mass after 24 hours PCT was 146.9% by mass for the silicon-containing aluminum nitride particles according Example 1 and 140.9% by mass for the silicon-containing aluminum nitride particles according to Example 2, relative to 100% by mass of the mass before PCT. The silicon-containing aluminum nitride particles according to Example 1 had a mass change rate of 46.9% by mass before and after PCT, and the silicon-containing aluminum nitride particles according to Example 2 had a mass change rate of 40.9% by mass before and after PCT. The silicon-containing aluminum nitride particles according to Examples 1 and 2 had a mass change rate of 50% by mass or less before and after PCT, and thus the mass change rate was inhibited even after PCT at high temperature and high humidity, and the moisture resistance was improved. In addition, the silicon-containing aluminum nitride particles according to Example 1 had an oxygen (O) mass ratio of 15.9% by mass after 24 hours PCT, as measured by the oxygen/nitrogen analyzer, and the silicon-containing aluminum nitride particles according to Example 2 had an oxygen (O) mass ratio of 32.3% by mass after 24 hours PCT. The silicon-containing aluminum nitride particles according to Examples 1 and 2 contained oxygen (O) even after PCT. In the silicon-containing aluminum nitride particles according to Examples 1 and 2, the oxygen (O) mass ratio after PCT, as measured by the oxygen/nitrogen analyzer, was larger than the oxygen (O) mass ratio before PCT, and thus it is presumed that hydroxyl groups (OH) were attached to the surface of the particles while the reaction between the silicon-containing aluminum nitride particles and moisture was inhibited.

The silicon-containing aluminum nitride particles according to Example 4 had a mass of 100.5% by mass after 24 hours PCT relative to 100% by mass of the mass before PCT. The silicon-containing aluminum nitride particles according to Example 4 had a mass change rate of 0.5% by mass before and after PCT, which was small, and thus the moisture resistance was further improved. In addition, the silicon-containing aluminum nitride particles according to Example 4 had an oxygen (O) mass ratio of 2.0% by mass after 24 hours PCT, as measured by the oxygen/nitrogen analyzer. The silicon-containing aluminum nitride particles according to Example 4 contained oxygen (O) even after PCT. In the silicon-containing aluminum nitride particles according to Example 4, the oxygen (O) mass ratio after PCT, as measured by the oxygen/nitrogen analyzer, was not larger than the oxygen (O) mass ratio before PCT compared to the silicon-containing aluminum nitride particles according to Examples 1 and 2, indicating that the reaction between the silicon-containing aluminum nitride particles and moisture was inhibited.

The aluminum nitride particles according to Comparative Example 1 had a mass of 152.1% by mass after 24 hours PCT relative to 100% by mass of the mass before PCT. The aluminum nitride particles according to Comparative Example 1 had a large mass change rate of 52.1% by mass before and after PCT, which was more than 50% by mass, and thus the moisture resistance was not improved. In addition, the aluminum nitride particles according to Comparative Example 1 had an oxygen (O) mass ratio of 16.2% by mass after 24 hours PCT, as measured by the oxygen/nitrogen analyzer. In the aluminum nitride particles according to Comparative Example 1, the oxygen (O) mass ratio after 24 hours PCT, as measured by the oxygen/nitrogen analyzer, was significantly larger than the oxygen (O) mass ratio before PCT, and thus it is presumed that the aluminum nitride particles reacted with moisture to increase the amount of oxygen (O).

The aluminum nitride particles according to Comparative Example 1 and the silicon-containing aluminum nitride particles according to Comparative Example 3 were each mixed with a silicone resin to prepare a bulk sample, and the thermal conductivity was measured as follows.

### Thermal Conductivity (W/m·K)

A mixed sample for thermal conductivity measurement in an amount of 100% by mass was prepared by mixing 50% by mass of the aluminum nitride particles according to Comparative Example 1 with 50% by mass of a silicone resin, and the mixed sample was cured to a size of 10 mm in length, 10 mm in width, and 0.5 mm or more and 1 mm or less in thickness, thereby preparing a bulk sample for thermal conductivity measurement according to Comparative Example 1. A bulk sample for thermal conductivity measurement according to Comparative Example 3 was prepared in the same or similar manner as in Comparative Example 1, except that the silicon-containing aluminum nitride particles according to Comparative Example 3 were used. The thermal conductivity of each of the obtained bulk samples for thermal conductivity measurement was measured using a laser flash analyzer (manufactured by NETZSCH). The thermal conductivity of a bulk sample (silicone resin of 100% by mass) obtained by curing only the silicone resin was 0.17 W/m·K.

The thermal conductivity of the bulk sample for thermal conductivity measurement according to Comparative Example 1 was 0.39 W/m·K, and the thermal conductivity of the bulk sample for thermal conductivity measurement according to Comparative Example 3 was 0.40 W/m·K. The thermal conductivity of the bulk sample according to Comparative Example 1 using the aluminum nitride particles according to Comparative Example 1, which was used as the raw material in Example 1, and the thermal conductivity of the bulk sample according to Comparative Example 3 using the silicon-containing aluminum nitride particles according to Comparative Example 3, which was prepared in the same or similar manner as in Example 1 except for using the aluminum nitride particles according to Comparative Example 1 and not performing the second heat treatment, were very close in value, indicating that the crystal structure of aluminum nitride was maintained and a part of aluminum was substituted with silicon to form silicon-containing aluminum nitride particles, thereby maintaining high thermal conductivity. The silicon-containing aluminum nitride particles according to Examples 1 to 5 had a ratio (X/Y) of 0.40 or more and 0.85 or less, and had an oxygen-containing film formed on the surface of the silicon-containing aluminum nitride particles while inhibiting the formation of aluminum oxide, and thus it is presumed that the high thermal conductivity of the silicon-containing aluminum nitride particles was maintained.

The silicon-containing aluminum nitride particles according to Example 4 and the silicon-containing aluminum nitride particles according to Comparative Example 3 were each mixed with a silicone resin, and the heat generation behavior was measured as follows.

### Heat Generation Behavior

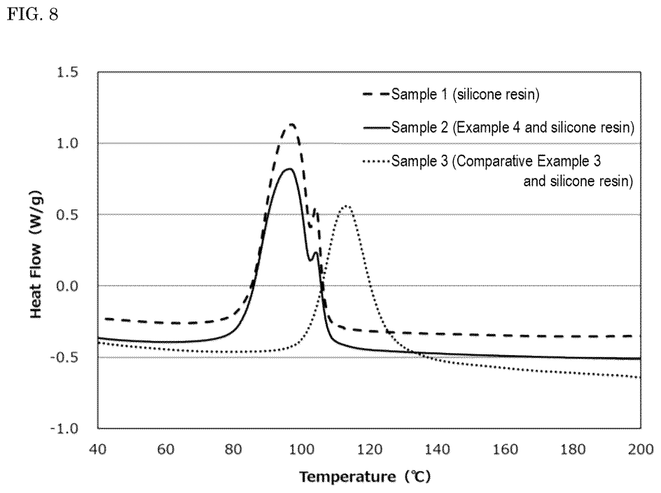

The heat generation behavior of each of the silicon-containing aluminum nitride particles according to Example 4 and the silicon-containing aluminum nitride particles according to Comparative Example 3 when added to a silicone resin was measured using a differential scanning calorimetry (DSC). The silicone resin in an amount of 100% by mass was used as a sample 1, the resin composition obtained by mixing 50% by mass of the silicon-containing aluminum nitride particles according to Example 4 with 50% by mass of the silicone resin was used as a sample 2, and the resin composition obtained by mixing 50% by mass of the silicon-containing aluminum nitride particles according to Comparative Example 3 with 50% by mass of the silicone resin was used as a sample 3. The DSC curve from 40° C. to 200° C. was measured by heating each sample from 30° C. to 299° C. at 10° C./min using a differential scanning calorimeter (DSC 2500, manufactured by TA Instruments). FIG. 8 shows the DSC curve of each sample.

As shown in FIG. 8, the resin composition containing the silicon-containing aluminum nitride particles according to Example 4, which is the sample 2, had a peak of the heat generation amount at the same temperature as the silicone resin of the sample 1, and thus exhibited a similar heat generation behavior to that of the silicone resin. Since the resin composition containing the silicon-containing aluminum nitride particles according to Example 4, which is the sample 2, had a peak of the heat generation amount at the same temperature as the silicone resin of the sample 1 and exhibited a similar heat generation behavior, it is presumed that the curing of the resin composition of the sample 2 was not inhibited and the reaction between the silicon-containing aluminum nitride particles according to Example 4 contained in the sample 2 and moisture was inhibited. On the other hand, the resin composition containing the silicon-containing aluminum nitride particles according to Comparative Example 3, which is the sample 3, had a peak of the heat generation amount at a different temperature than the silicone resin of the sample 1, and thus had a different heat generation behavior than the silicone resin of the sample 1.

### Example 6

A raw material mixture was obtained by mixing 94.7% by mass of aluminum nitride powder and 5.3% by mass of silicon nitride powder, relative to a total of aluminum nitride powder and silicon nitride powder being 100% by mass.

The resulting raw material mixture was filled into a container whose material was made of boron nitride. The raw material mixture filled in the container was subjected to a first heat treatment at 1,700° C. for 4 hours under a pressure of 0.92 MPa in a nitrogen atmosphere with 100% by volume of nitrogen gas to obtain a first heat-treated product.

The resulting first heat-treated product in an amount of 100 g was dispersed in 400 g of deionized water, and then wet-dispersed at room temperature of 20° C. for 1 hour in a ball mill using 200 g of alumina balls having a diameter (φ) of 2 mm.

The first heat-treated product after wet dispersion was subjected to solid-liquid separation and dried at 100° C. for 10 hours.

The first heat-treated product after wet dispersion and drying was subjected to a second heat treatment at 900° C. for 10 hours under atmospheric pressure (0.101 MPa) in an air atmosphere to obtain a second heat-treated product.

The second heat-treated product was subjected to a classification treatment by dry sieving to obtain silicon-containing aluminum nitride particles as the second heat-treated product.

The presence or absence of silicon nitride (Si₃N₄) in the raw material mixture, the first heat treatment temperature, the wet dispersion time, the average particle diameter D of the first heat-treated product after wet dispersion and drying measured by the Fisher Sub-Sieve Sizer method, the volume median diameter Dm measured by the laser diffraction particle size distribution measurement method, the particle diameter ratio D/Dm of the average particle diameter D to the volume median diameter Dm, the second heat treatment temperature and time, and the presence or absence of a SiO₂ film attached to the surface of the second heat-treated product are shown in Table 3. In Table 3, if there is no silicon nitride (Si₃N₄) in the raw material mixture, if there is no coating layer containing silicon dioxide (SiO₂), or if no specific treatment is performed, the column is marked “absent” or “n/a”.

### Example 7

Silicon-containing aluminum nitride particles as the second heat-treated product were obtained in the same or similar manner as in Example 6, except that the raw material mixture was obtained by mixing 89.4% by mass of aluminum nitride powder and 10.6% by mass of silicon nitride powder, relative to a total of aluminum nitride powder and silicon nitride powder being 100% by mass.

### Comparative Example 6

The first heat-treated product obtained after wet dispersion and drying obtained in the same or similar manner as in Example 6, except that the second heat treatment was not performed, was used as silicon-containing aluminum nitride particles according to Comparative Example 6.

### Comparative Example 7

The aluminum nitride particles used as the raw material in Example 6 were used as aluminum nitride particles according to Comparative Example 7.

### Average Particle Diameter D and Volume Median Diameter Dm

For the first heat-treated product after wet dispersion and drying according to each of Examples 6 and 7 and Comparative Examples 6 and 7, the average particle diameter according to the FSSS method and the volume median diameter Dm according to the laser diffraction particle size distribution measurement method were measured in the same or similar manner as for the first heat-treated product in Example 1. The results are shown in Table 3.

TABLE 3

| | | | | First heat-treated product | | | | | |
|---|---|---|---|---|---|---|---|---|---|
| | | | | Average | Volume | | Second heat treatment | | |
| | Silicon nitride | First heat | Wet | particle | median | Particle | Second heat | Second heat | |
| | (Si₃N₄) in raw | treatment | dispersion | diameter | diameter | diameter | treatment | treatment | Silicon |
| | material | temperature | time | D | Dm | ratio | temperature | time | dioxide |
| | mixture | (° C.) | (h) | (μm) | (μm) | D/Dm | (° C.) | (h) | (SiO₂) |
| Example 6 | present | 1700 | 1 | 44.6 | 51.5 | 0.864 | 900 | 10 | absent |
| Example 7 | present | 1700 | 1 | 30.5 | 48.8 | 0.625 | 900 | 10 | absent |
| Comparative | present | 1700 | 1 | 44.5 | 51.5 | 0.864 | n/a | n/a | absent |
| Example 6 | | | | | | | | | |
| Comparative | absent | n/a | n/a | 45.0 | 44.4 | 1.014 | n/a | n/a | absent |
| Example 7 | | | | | | | | | |

The silicon-containing aluminum nitride particles according to each of Examples 6 and 7 and Comparative Example 6, and the aluminum nitride particles according to Comparative Example 7 were subjected to the following evaluations. The results are shown in Tables 4 and 5. In Table 4, the symbol “-” indicates that the numerical value for the corresponding item has not been measured.

The resulting silicon-containing aluminum nitride p articles according to each of Examples 6 and 7 and Comparative Example 6, and the aluminum nitride particles according to Comparative Example 7 were subjected to composition analysis in the same or similar manner as in Example 1. Aluminum (Al) and silicon (Si) in each of the particles were quantitatively analyzed using an inductively coupled plasma-atomic emission spectroscope (ICP-AES) to determine the mass of aluminum (Al) and the mass of silicon (Si) in each of the particles. The mass of oxygen (O) and the mass of nitrogen (N) in each of the particles were quantitatively analyzed using an oxygen/nitrogen analyzer (manufactured by HORIBA, Ltd.). The numerical values of Al, Si, O, and N in Table 4 are the mass ratios of the elements when the total of the mass of aluminum, the mass of silicon, the mass of nitrogen, and the mass of oxygen is 1000% by mass. When each of the silicon-containing aluminum nitride particles had a composition represented by Al₁₋ₓSiₓN and contained oxygen, the parameter x representing the molar ratio of Si was determined relative to the molar ratio of N in 1 mol of the composition being 1. The silicon-containing aluminum nitride particles according to Example 6 had a parameter x of 0.04 (x=0.04) in the composition represented by Al₁₋ₓSiₓN, had a composition represented by Al_{0.96}Si_{0.04}N, and contained oxygen. The silicon-containing aluminum nitride particles according to Example 7 had a parameter x of 0.07 (x=0.07) in the composition represented by Al₁₋ₓSiₓN, had a composition represented by Al_{0.93}Si_{0.07}N, and contained oxygen. The silicon-containing aluminum nitride particles according to Comparative Example 6 had a parameter x of 0.04 (x=0.04) in the composition represented by Al₁₋ₓSiₓN, had a composition represented by Al_{0.96}Si_{0.04}N, and contained oxygen. The aluminum nitride particles according to Comparative Example 7 had a parameter x of 0 (x=0) and a composition represented by AlN.

### X-Ray Photoelectron Spectroscopy

Using an XPS system (PHI Quantera II, manufactured by ULVAC-PHI Inc.), the nitrogen atomic percentage N^{P} (at %) and the oxygen atomic percentage O^{P} (at %) in the silicon-containing aluminum nitride particles according to each of Examples and Comparative Examples were measured according to X-ray photoelectron spectroscopy (XPS), and the ratio O^{P}/N^{P} of the oxygen atomic percentage O^{P} (at %) to the nitrogen atomic percentage N^{P} (at %) was determined. No measurement was performed on the silicon-containing aluminum nitride particles according to Example 7.

### X-Ray Fluorescence Spectrometry

Using an X-ray fluorescence spectrometer (ZSX Primus II, manufactured by Rigaku Corporation), the peak intensity of Ka rays of the aluminum (Al) element and the peak intensity of Ka rays of the nitrogen (N) element in the silicon-containing aluminum nitride particles according to each of Examples and Comparative Examples were measured according to X-ray fluorescence spectrometry (XRF), and the ratio Al^{Ka}/N^{Ka} of the peak intensity of the aluminum Ka rays to the peak intensity of the nitrogen Ka rays was determined. No measurement was performed on the silicon-containing aluminum nitride particles according to Example 7.

### X-Ray Diffraction Pattern and Peak Intensity

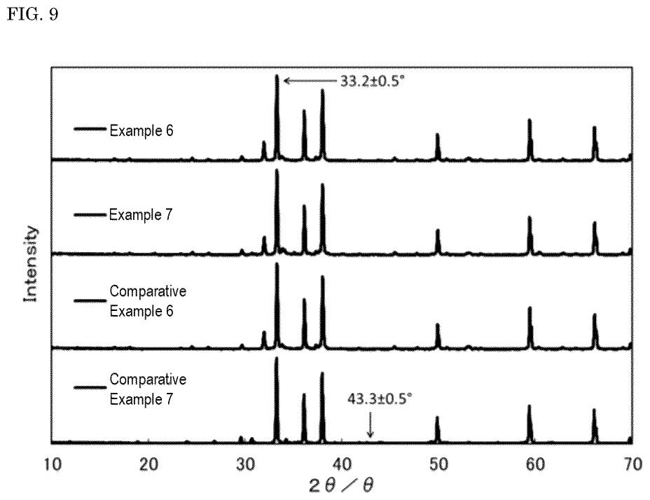

For the silicon-containing aluminum nitride particles according to each of Examples 6 and 7 and Comparative Example 6, and the aluminum nitride particles according to Comparative Example 7, the X-ray diffraction pattern was measured in the same or similar manner as in Example 1. FIG. 9 shows the X-ray diffraction pattern of the silicon-containing aluminum nitride particles according to each of Examples 6 and 7 and Comparative Example 6, and the X-ray diffraction pattern of the aluminum nitride particles according to Comparative Example 7. In the X-ray diffraction pattern of the silicon-containing aluminum nitride particles according to each of Examples 6 and 7 and Comparative Example 6, and the X-ray diffraction pattern of the aluminum nitride particles according to Comparative Example 7, the ratio of the peak intensity at a diffraction angle 2θ of 43.3°±0.5° to 100% of the peak intensity at a diffraction angle 2θ of 33.2°±0.5° was determined.

### Average Particle Diameter D

For the silicon-containing aluminum nitride particles according to each of Examples 6 and 7 and Comparative Example 6, and the aluminum nitride particles according to Comparative Example 7, the average particle diameter D was determined by the FSSS method in the same or similar manner as in Example 1.

### Reflectance Spectrum

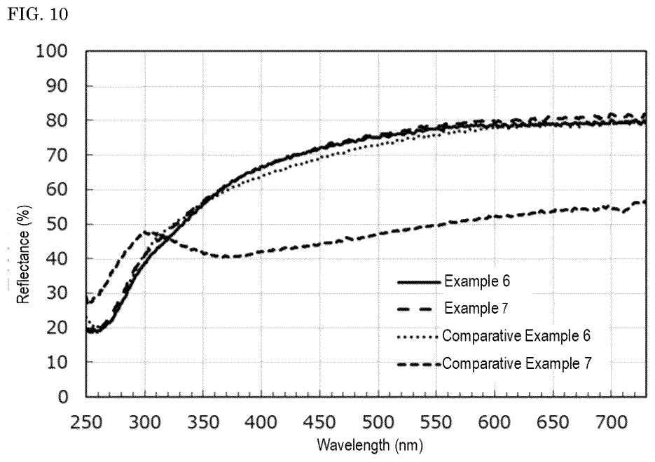

For the silicon-containing aluminum nitride particles according to each of Examples 6 and 7 and Comparative Example 6, and the aluminum nitride particles according to Comparative Example 7, the reflectance was determined in the same or similar manner as in Example 1. FIG. 10 shows the reflectance spectrum of the silicon-containing aluminum nitride particles according to each of Examples 6 and 7 and Comparative Example 6, and the reflectance spectrum of the aluminum nitride particles according to Comparative Example 7. The reflectances at 250 nm, 380 nm, 450 nm, and 730 nm of the silicon-containing aluminum nitride particles according to each of Examples 6 and 7 and Comparative Example 6, and the aluminum nitride particles according to Comparative Example 7 are also shown in Table 4.

### Pressure Cooker Test (PCT)

For the silicon-containing aluminum nitride particles according to each of Examples 6 and 7 and Comparative Example 6, and the aluminum nitride particles according to Comparative Example 7, the pressure cooker test (PCT) was performed in the same or similar manner as in Example 1, and the mass ratios of the sample before and after PCT were measured in the same or similar manner as in the measurement of the silicon-containing aluminum nitride particles according to Example 1 described above. The mass change rate (%) was calculated by subtracting the mass ratio before PCT (100%) from the mass ratio after PCT. The mass of oxygen (O) in the sample before and after PCT was detected by quantitative analysis using an oxygen/nitrogen analyzer (manufactured by HORIBA, Ltd.) in the same or similar manner as in the measurement of the silicon-containing aluminum nitride particles according to Example 1 described above. The numerical value of the mass of oxygen (O) in the sample before and after PCT detected by the oxygen/nitrogen analyzer was expressed as a mass ratio (% by mass) by dividing by the numerical value of the mass of the silicon-containing aluminum nitride particles (sample) fed into the oxygen/nitrogen analyzer, and multiplying by 100. The results are shown in Table 5.

### Thermal Conductivity (W/m·K)

A mixed sample for thermal conductivity measurement in an amount of 100% by mass was prepared by mixing 80% by mass of the silicon-containing aluminum nitride particles according to each of Examples 6 and 7 with 20% by mass of a silicone resin, and the mixed sample was cured to a size of 10 mm in length, 10 mm in width, and 0.5 mm or more and 1 mm or less in thickness, thereby preparing a bulk sample for thermal conductivity measurement in the same or similar manner as in Comparative Example 1. The thermal conductivity of each of the obtained bulk samples for thermal conductivity measurement was measured in the same or similar manner as in Comparative Example 1.

### SEM Micrograph

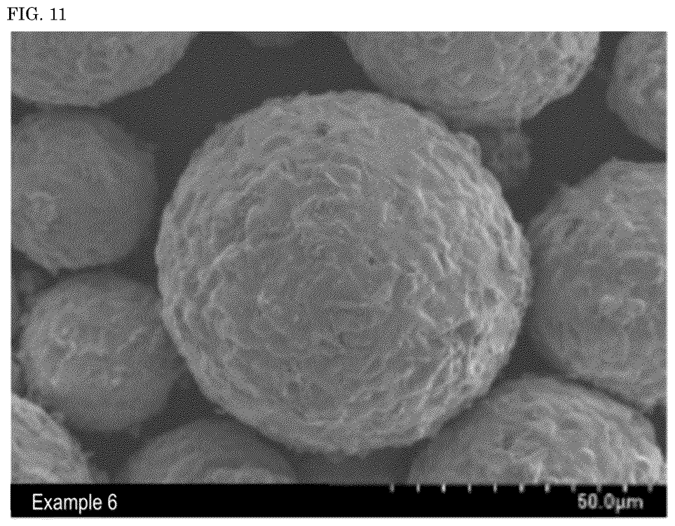

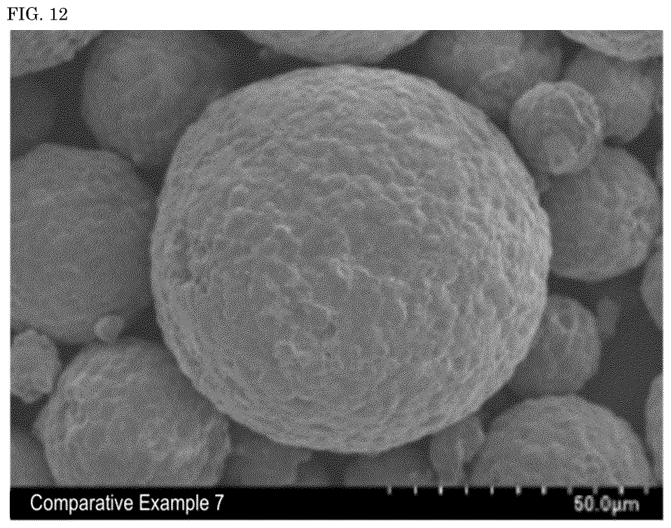

SEM micrographs of the silicon-containing aluminum nitride particles according to Example 6 and the aluminum nitride particles according to Comparative Example 7 were obtained in the same or similar manner as in Example 1. FIG. 11 is an SEM micrograph of the silicon-containing aluminum nitride particles according to Example 6. FIG. 12 is an SEM micrograph of the aluminum nitride particles according to Comparative Example 7.

TABLE 4

| | Particle analysis by ICP and | | | | | | | | Peak | Average | | | | |
|---|---|---|---|---|---|---|---|---|---|---|---|---|---|---|
| | oxygen/nitrogen analyzers | | | | | | | Particle | intensity | particle | | | | |
| | (% by mass) | | | | Particle analysis by XPS | | | analysis | (%) | diameter | | | | |
| | | | O | | O | N | | by XRF | (43.3°/ | D | Reflectance (%) | | | |
| | Al | Si | (X) | N | (at %) | (at %) | O°/N° | Al [symbol] /N [symbol] | 33.2°) | (μm) | 250 nm | 380 nm | 450 nm | 730 nm |
| Example 6 | 62.16 | 2.41 | 1.81 | 33.61 | 46.8 | 9.2 | 5.09 | 765.0 | 1.18 | 42.5 | 18.8 | 63.3 | 72.0 | 79.1 |
| Example 7 | 59.28 | 4.70 | 1.74 | 34.30 | — | — | — | — | 1.89 | 29.5 | 19.8 | 63.2 | 92.3 | 81.9 |
| Comparative | 62.03 | 2.41 | 1.70 | 33.88 | 27.6 | 23.7 | 1.46 | 737.7 | 1.44 | 44.5 | 23.0 | 61.2 | 68.9 | 79.6 |
| Example 6 | | | | | | | | | | | | | | |
| Comparative | 65.26 | 0.01 | 1.76 | 32.97 | 32.8 | 17.2 | 1.91 | 817.1 | 0.95 | 45.0 | 28.9 | 40.6 | 44.2 | 55.9 |
| Example 7 | | | | | | | | | | | | | | |

[symbol]

indicates data missing or illegible when filed

TABLE 5

| | Before PCT | After 24 hours PCT | | |
|---|---|---|---|---|
| | Mass ratio of | | Mass change | Mass ratio of |
| | oxygen (O) | Mass ratio | rate | oxygen (O) |
| | (% by mass) | (% by mass) | (%) | (% by mass) |
| Example 6 | 1.7 | 100.2 | 0.2 | 2.0 |
| Example 7 | 1.7 | 99.9 | −0.1 | 1.7 |
| Comparative | 1.6 | 101.0 | 1.0 | 2.3 |
| Example 6 | | | | |
| Comparative | 1.7 | 102.5 | 2.5 | 4.3 |
| Example 7 | | | | |

As shown in Table 4, the silicon-containing aluminum nitride particles according to Example 6 had a ratio O^{P}/N^{P} of the oxygen atomic percentage O^{P} (at %) to the nitrogen atomic percentage N^{P} (at %), as obtained by analyzing the particles by XPS, of more than 2.0. The silicon-containing aluminum nitride particles according to each of Examples 6 and 7 had an average particle diameter measured by the FSSS method of more than 3.0 μm and 100 μm or less. The silicon-containing aluminum nitride particles according to each of Examples 6 and 7 had an oxygen-containing film formed on the surface of the silicon-containing aluminum nitride particles having a large average particle diameter while inhibiting the formation of aluminum oxide.

The silicon-containing aluminum nitride particles according to each of Examples 6 and 7 had a ratio of the total of the mass of aluminum and the mass of nitrogen of 90% by mass or more, and a ratio of the mass of silicon of 1.5% by mass or more and 10.0% by mass or less, relative to the total of the masses of aluminum, silicon, nitrogen, and oxygen being 100% by mass, as obtained by analyzing the particles. In addition, the silicon-containing aluminum nitride particles according to each of Examples 6 and 7 had a composition represented by A₁₋ₓSiₓN (x=0.04 or x=0.07) and contained oxygen.

The silicon-containing aluminum nitride particles according to Example 6 had a ratio Al^{Ka}/N^{Ka} of the peak intensity of the aluminum Ka rays to the peak intensity of the nitrogen Ka rays, as obtained by analyzing the particles by XRF, of 740 or more. Therefore, it can be confirmed that the silicon-containing aluminum nitride particles according to Example 6 were covered with an oxygen-containing film.

As shown in Table 5, the silicon-containing aluminum nitride particles according to each of Examples 6 and 7 had a mass change rate of 1% or less before and after PCT, indicating that there was almost no mass change even after PCT of high temperature and high humidity, and the moisture resistance of the silicon-containing aluminum nitride particles having a large average particle diameter was improved.

As shown in Table 4 and FIG. 9, the silicon-containing aluminum nitride particles according to each of Examples 6 and 7 had a peak intensity at a diffraction angle 2θ of 43.3°+0.5° of 2% or less relative to 100% of the peak intensity at a diffraction angle 2θ of 33.2°+0.5° in the powder X-ray diffraction pattern measured using CuKa rays (1.5418 Å), indicating that the silicon-containing aluminum nitride particles was inhibited the formation of aluminum oxide on the surface.

The silicon-containing aluminum nitride particles according to each of Examples 6 and 7 had an average particle diameter, as measured by the FSSS method, of more than 25 μm, and the bulk sample containing the silicon-containing aluminum nitride particles according to each of Examples 6 and 7 and the silicone resin had a thermal conductivity that was 7 to nearly 10 times higher than that of the bulk sample obtained by curing the silicone resin alone. The bulk sample obtained by curing the silicone resin alone (100% by mass of silicone resin) had a thermal conductivity of 0.17 W/m·K. The bulk sample using the silicon-containing aluminum nitride particles according to Example 6 had a thermal conductivity of 1.69 W/m·K. The bulk sample using the silicon-containing aluminum nitride particles according to Example 7 had a thermal conductivity of 1.24 W/m·K.

As shown in Table 4 and FIG. 10, the silicon-containing aluminum nitride particles according to each of Examples 6 and 7 maintained a high reflectance, with a reflectance of 60% or more for light in the visible light region of 380 nm or more and 730 nm or less. In addition, the silicon-containing aluminum nitride particles according to each of Examples 6 and 7 had a reflectance of 40% or less for light having a wavelength of 250 nm, indicating that the silicon-containing aluminum nitride particles easily absorbed light having a wavelength of 200 nm to less than 380 nm, which is the wavelength in the ultraviolet region around 250 nm, and, when dispersed, for example, in a resin, inhibited deterioration of the resin due to ultraviolet rays.

As shown in the SEM micrograph in FIG. 11, the silicon-containing aluminum nitride particles according to Example 6 had an average particle diameter, as measured by the FSSS method, of more than 3.0 μm and 100 μm or less, specifically 42.5 μm, and even when the average particle diameter was large, there were few secondary particles and many primary particles, and thus it is presumed that an oxygen-containing film was uniformly formed on the surface of the primary particles. Since the silicon-containing aluminum nitride particles according to Example 6 had an oxygen-containing film formed on the surface of the primary particles, the unevenness on the surface of the particles was more clearly observed than on the surface of the aluminum nitride particles according to Comparative Example 7, which is the raw material, as shown in the SEM micrograph in FIG. 12 described below.

The silicon-containing aluminum nitride particles according to Comparative Example 6 had no oxygen-containing film formed on the surface of the particles since the second heat treatment was not performed. Since the silicon-containing aluminum nitride particles according to Comparative Example 6 did not have a significant increase in oxygen content, it is presumed that hydroxyl groups were attached to the surface of the particles. Since the silicon-containing aluminum nitride particles according to Comparative Example 6 had no oxygen-containing film formed on the surface of the particles, the ratio O^{P}/N^{P} of the oxygen atomic percentage O^{P} (at %) to the nitrogen atomic percentage N^{P} (at %), as obtained by analyzing the particles by XPS, was 2.0 or less, and the mass change rate after PCT of high temperature and high humidity was 1%, which was a larger mass change rate and less improvement in moisture resistance compared to the silicon-containing aluminum nitride particles according to Examples 6 and 7 having an oxygen-containing film on the surface.

The silicon-containing aluminum nitride particles according to Comparative Example 6 had a ratio Al^{Ka}/N^{Ka} of the peak intensity of the aluminum Ka rays to the peak intensity of the nitrogen Ka rays, as obtained by analyzing the particles by XRF, of less than 740, indicating that the surface of the silicon-containing aluminum nitride particles according to Comparative Example 6 was not covered with an oxygen-containing film.

The aluminum nitride particles according to Comparative Example 7, which is the raw material for the silicon-containing aluminum nitride particles according to each of Examples 6 and 7 and Comparative Example 6, had no oxygen-containing film formed on the surface of the particles since the first and second heat treatments were not performed. Since the aluminum nitride particles according to Comparative Example 7 did not have a significant increase in oxygen content, it is presumed that hydroxyl groups were attached to the surface of the particles. Since the aluminum nitride particles according to Comparative Example 7 had no oxygen-containing film formed on the surface, the ratio O^{P}/N^{P} of the oxygen atomic percentage O^{P} (at %) to the nitrogen atomic percentage N^{P} (at %), as obtained by analyzing the particles by XPS, was 2.0 or less, and the mass change rate after PCT of high temperature and high humidity was large at 2.5%, indicating that the moisture resistance was not improved.

The aluminum nitride particles according to Comparative Example 7 had a ratio Al^{Ka}/N^{Ka} of the peak intensity of the aluminum Ka rays to the peak intensity of the nitrogen Ka rays, as obtained by analyzing the particles by XRF, of 817.1, which was more than 810. The aluminum nitride particles according to Comparative Example 7 were aluminum nitride particles used as a raw material that were not subjected to the first and second heat treatments, and it is presumed that the aluminum in the aluminum nitride reacted with oxygen to form aluminum oxide on the surface of the particles.

The aluminum nitride particles according to Comparative Example 7, although the reflectance for light having a wavelength of 250 nm was 40% or less, had a large reflectance for light having a wavelength of 280 nm to 320 nm or less, which is the wavelength in the ultraviolet region, of more than 40%, and it is presumed that the particles were less likely to absorb light having a wavelength in the ultraviolet region, resulting in less suppression of deterioration of the polymer containing a resin and the like due to ultraviolet rays.

As shown in the SEM micrograph in FIG. 12, the surface of the aluminum nitride particles according to Comparative Example 7 was not significantly changed compared to the silicon-containing aluminum nitride particles according to Example 6 shown in FIG. 11. Since the aluminum nitride particles according to Comparative Example 7 had no oxygen-containing film formed on the surface of the particles, the surface was observed to have a smoother surface than that of the silicon-containing aluminum nitride particles according to Example 6 shown in the SEM micrograph in FIG. 11, with a smaller difference in the height of the surface unevenness.

The silicon-containing aluminum nitride particles according to the present disclosure can be used in a sintered body or a resin composition. The sintered body containing the silicon-containing aluminum nitride particles can be used in a support for heat sinks or electronic components. The resin composition containing the silicon-containing aluminum nitride particles can be used, for example, in a molded body or a sealing material for light emitting devices. In addition, the resin composition containing the silicon-containing aluminum nitride particles can be used in a bonding member, such as a die-bonding material for die-bonding a light emitting element or a semiconductor element to a support, or as an underfill material.

What is claimed is:

1. Silicon-containing aluminum nitride particles comprising:
a ratio of a total of a mass of aluminum and a mass of nitrogen of 90% by mass or more, and a ratio of a mass of silicon of 1.5% by mass or more and 10.0% by mass or less relative to a total of the mass of aluminum and the mass of silicon, as obtained by analyzing particles using an inductively coupled plasma-atomic emission spectroscope, and a mass of oxygen and the mass of nitrogen, as obtained by analyzing the particles using an oxygen/nitrogen analyzer, being 100% by mass,
wherein a ratio (X/Y) of a numerical value X of the X % by mass to a numerical value Y of the Y m²/g is 0.40 or more and 0.85 or less, a ratio of the mass of oxygen is denoted as X % by mass, a specific surface area of the particles, as measured according to a BET method, is denoted as Y m²/g.

2. Silicon-containing aluminum nitride particles comprising:
a ratio of a total of a mass of aluminum and a mass of nitrogen of 90% by mass or more, and a ratio of a mass of silicon of 1.5% by mass or more and 10.0% by mass or less relative to a total of the mass of aluminum and the mass of silicon, as obtained by analyzing particles using an inductively coupled plasma-atomic emission spectroscope, and a mass of oxygen and the mass of nitrogen, as obtained by analyzing the particles using an oxygen/nitrogen analyzer, being 100% by mass,
wherein a ratio O^{P}/N^{P} of an oxygen atomic percentage O^{P} to a nitrogen atomic percentage N^{P}, as obtained by analyzing the particles according to X-ray photoelectron spectroscopy, is more than 2.0.

3. The silicon-containing aluminum nitride particles according to claim 1, wherein a ratio of the mass of oxygen is 0.9% by mass or more and 3.5% by mass or less relative to the total of the mass of aluminum, the mass of silicon, the mass of nitrogen, and the mass of oxygen being 100% by mass.

4. The silicon-containing aluminum nitride particles according to claim 1, wherein a specific surface area of the particles, as measured according to a BET method, is 2.5 m²/g or more and 4.5 m²/g or less.

5. The silicon-containing aluminum nitride particles according to claim 1, wherein a ratio of the mass of silicon is 1.5% by mass or more and 4.0% by mass or less relative to the total of the mass of aluminum, the mass of silicon, the mass of nitrogen, and the mass of oxygen being 100% by mass.

6. The silicon-containing aluminum nitride particles according to claim 2, wherein a ratio Al^{Ka}/N^{Ka} of a peak intensity Al^{Ka} of aluminum Ka rays to a peak intensity N^{Ka} of nitrogen Ka rays, as obtained by analyzing the particles according to X-ray fluorescence spectrometry, is more than 740.

7. The silicon-containing aluminum nitride particles according to claim 1, having a composition represented by Al₁₋ₓSiₓN and comprising oxygen, wherein x satisfies 0.02≤x≤0.2.

8. The silicon-containing aluminum nitride particles according to claim 1, wherein an average particle diameter, as measured according to a Fisher Sub-Sieve Sizer method, is 0.1 μm or more and 100 μm or less.

9. The silicon-containing aluminum nitride particles according to claim 1, wherein an average particle diameter, as measured according to a Fisher Sub-Sieve Sizer method, is 0.5 μm or more and 3.0 μm or less.

10. The silicon-containing aluminum nitride particles according to claim 2, wherein an average particle diameter, as measured according to a Fisher Sub-Sieve Sizer method, is more than 3.0 μm and 80 μm or less.

11. The silicon-containing aluminum nitride particles according to claim 1, wherein in a powder X-ray diffraction pattern measured using CuKa rays (1.5418 Å), a peak intensity at a diffraction angle 2θ of 43.3°±0.5° is 5% or less relative to a peak intensity at a diffraction angle 2θ of 33.2°±0.5° being 100%.

12. The silicon-containing aluminum nitride particles according to claim 1, wherein a reflectance for light having a wavelength range of 380 nm or more and 730 nm or less is 50% or more.

13. The silicon-containing aluminum nitride particles according to claim 1, wherein a reflectance for light having a wavelength range of 380 nm or more and 730 nm or less is 80% or more.

14. The silicon-containing aluminum nitride particles according to claim 1, wherein a reflectance for light having a wavelength of 250 nm is 40% or less.

15. The silicon-containing aluminum nitride particles according to claim 1, wherein when 1.0 g of the silicon-containing aluminum nitride particles is brought into contact with 50 mL of a boiled 6 mol/L hydrochloric acid aqueous solution, an amount of ammonia generated in the hydrochloric acid aqueous solution is 120 ppm by mass or less.

16. The silicon-containing aluminum nitride particles according to claim 2, having a composition represented by Al₁₋ₓSiₓN and comprising oxygen, wherein x satisfies 0.02≤x≤0.2.

17. The silicon-containing aluminum nitride particles according to claim 2, wherein an average particle diameter, as measured according to a Fisher Sub-Sieve Sizer method, is 0.1 μm or more and 100 μm or less.

18. The silicon-containing aluminum nitride particles according to claim 2, wherein in a powder X-ray diffraction pattern measured using CuKa rays (1.5418 Å), a peak intensity at a diffraction angle 2θ of 43.3°±0.5° is 5% or less relative to a peak intensity at a diffraction angle 2θ of 33.2°±0.5° being 100%.

19. The silicon-containing aluminum nitride particles according to claim 2, wherein a reflectance for light having a wavelength range of 380 nm or more and 730 nm or less is 50% or more.

20. The silicon-containing aluminum nitride particles according to claim 2, wherein a reflectance for light having a wavelength of 250 nm is 40% or less.

21. A sintered body comprising the silicon-containing aluminum nitride particles according to claim 1.

22. A resin composition comprising the silicon-containing aluminum nitride particles according to claim 1 and a resin.

23. A sintered body comprising the silicon-containing aluminum nitride particles according to claim 2.

24. A resin composition comprising the silicon-containing aluminum nitride particles according to claim 2 and a resin.

25. A method for producing silicon-containing aluminum nitride particles comprising:
mixing aluminum nitride and silicon nitride to obtain a raw material mixture containing silicon nitride in an amount of 2% by mass or more and 15% by mass or less relative to a total of aluminum nitride and silicon nitride being 100% by mass;
subjecting the raw material mixture to a first heat treatment at a pressure of 0.101 MPa or more and a temperature of 1,600° C. or higher and 2,100° C. or lower to obtain a first heat-treated product; and
subjecting the obtained first heat-treated product to a second heat treatment at a temperature of 850° C. or higher and lower than 1,000° C. to obtain a second heat-treated product.

26. The method for producing silicon-containing aluminum nitride particles according to claim 25, further comprising wet dispersing the first heat-treated product prior to the second heat treatment.

27. The method for producing silicon-containing aluminum nitride particles according to claim 25, further comprising subjecting the first heat-treated product to the second heat treatment in an oxygen-containing atmosphere for 1 hour or more and 15 hours or less.

28. The method for producing silicon-containing aluminum nitride particles according to claim 26, further comprising: subjecting the first heat-treated product to solid-liquid separation after the wet dispersion; and drying the product in a temperature range of 80° C. or higher and 120° C. or lower.

29. The method for producing silicon-containing aluminum nitride particles according to claim 26, wherein a particle diameter ratio D/Dm of an average particle diameter D, as obtained by measuring the first heat-treated product after the wet dispersion according to a Fisher Sub-Sieve Sizer method, to a volume median diameter Dm, as obtained by measuring the first heat-treated product after the wet dispersion according to a laser diffraction particle size distribution measurement method, is 0.2 or more and 0.5 or less.

30. The method for producing silicon-containing aluminum nitride particles according to claim 26, wherein a particle diameter ratio D/Dm of an average particle diameter D, as obtained by measuring the first heat-treated product after the wet dispersion according to a Fisher Sub-Sieve Sizer method, to a volume median diameter Dm, as obtained by measuring the first heat-treated product after the wet dispersion according to a laser diffraction particle size distribution measurement method, is 0.55 or more and 0.95 or less.

31. The method for producing silicon-containing aluminum nitride particles according to claim 25, wherein the second heat-treated product comprises silicon-containing aluminum nitride particles having a ratio of a total of a mass of aluminum and a mass of nitrogen of 90% by mass or more, and a ratio of a mass of silicon of 1.5% by mass or more and 10.0% by mass or less relative to a total of the mass of aluminum and the mass of silicon, as obtained by analyzing the particles using an inductively coupled plasma-atomic emission spectroscope, and the mass of nitrogen and a mass of oxygen, as obtained by analyzing the particles using an oxygen/nitrogen analyzer, being 100% by mass,
wherein a ratio (X/Y) of a numerical value X of the X % by mass to a numerical value Y of the Y m²/g is 0.40 or more and 0.85 or less, a ratio of the mass of oxygen is denoted as X % by mass, a specific surface area of the particles, as measured according to a BET method, is denoted as Y m²/g.

32. The method for producing silicon-containing aluminum nitride particles according to claim 25, wherein the second heat-treated product comprises silicon-containing aluminum nitride particles having a ratio of a total of a mass of aluminum and a mass of nitrogen of 90% by mass or more, and a ratio of a mass of silicon of 1.5% by mass or more and 10.0% by mass or less relative to a total of the mass of aluminum and the mass of silicon, as obtained by analyzing the particles using an inductively coupled plasma-atomic emission spectroscope, and the mass of nitrogen and a mass of oxygen, as obtained by analyzing the particles using an oxygen/nitrogen analyzer, being 100% by mass,
wherein a ratio O^{P}/N^{P} of an oxygen atomic percentage O^{P} to a nitrogen atomic percentage N^{P}, as obtained by analyzing the particles according to X-ray photoelectron spectroscopy, is more than 2.0.
